(19) United States
(12) Patent Application Publication
(10) Pub. No.: US 2026/0067921 A1
(43) Pub. Date: Mar. 5, 2026

(54) COLLISION HANDLING FOR SBFD OPERATION IN CA

(71) Applicant: QUALCOMM Incorporated, San Diego, CA (US)

(72) Inventors: Muhammad Sayed Khairy ABDELGHAFFAR, San Jose, CA (US); Jae Ho RYU, San Diego, CA (US); Heechoon LEE, San Diego, CA (US); Prashant SHARMA, San Marcos, CA (US)

(21) Appl. No.: 18/823,450

(22) Filed: Sep. 3, 2024

(51) Int. Cl. H04W 72/566; H04L 5/14; H04W 72/1263

(52) U.S. Cl. CPC H04W 72/566; H04L 5/14; H04W 72/1263

(57) ABSTRACT

The apparatus may be a wireless device configured to receive, for a first symbol, an indication of a plurality of scheduled transmissions comprising a first downlink transmission in a downlink direction and a second uplink transmission in an uplink direction, wherein the plurality of scheduled transmissions comprises at least one transmission associated with a first serving cell operating in a sub-band full duplex (SBFD) mode of operation and an additional transmission associated with an additional serving cell in a plurality of serving cells, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells.

### TECHNICAL FIELD

The present disclosure relates generally to communication systems, and more particularly, to collision handling in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device configured to receive, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a sub-band full duplex (SBFD) mode of operation and an additional transmission associated with an additional serving cell in a plurality of serving cells, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a set of diagrams illustrating a base station engaging in FD communication, a UE engaging in FD communication, and both a base station and a UE engaging in FD communication.

FIG. 5 is a diagram illustrating example resource allocations for in-band full duplex (IBFD) mode communication and SBFD mode communication.

FIG. 6 is a diagram illustrating the cancellation of an UL transmission that overlaps with a synchronization signal block (SSB) transmission in accordance with some aspects of the disclosure.

FIG. 7A is a diagram illustrating a first set of component carriers and associated scheduled transmissions in a first frequency band in accordance with some aspects of the disclosure.

FIG. 7B is a diagram illustrating a first set of component carriers and associated scheduled transmissions in a first frequency band and a second set of component carriers and associated scheduled transmissions in a second frequency band in accordance with some aspects of the disclosure.

FIG. 8A is a diagram illustrating a first method of resolving conflicts within a single frequency band in accordance with some aspects of the disclosure.

FIG. 8B is a diagram illustrating a second method of resolving conflicts within a single frequency band in accordance with some aspects of the disclosure.

FIG. 9A is a diagram illustrating a third method of resolving conflicts within a single frequency band in accordance with some aspects of the disclosure.

FIG. 9B is a diagram illustrating a fourth method of resolving conflicts within a single frequency band in accordance with some aspects of the disclosure.

FIG. 10 is a call flow diagram illustrating a method of wireless communication in accordance with some aspects of the disclosure.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

In some aspects of wireless communication, a plurality of UEs may operate in a half duplex (HD) mode of operation while a base station operates in a SBFD mode of operation. The SBFD mode of operation, in some aspects, may reduce latency by allowing transmission of UL channels and/or signals in an UL sub-band in SBFD symbols and/or slots and reception of DL channels and/or signals in DL sub-bands in the SBFD symbols and/or slots, may enhance UL coverage, and may allow for flexible and/or dynamic UL/DL resource adaptation based on UL and/or DL traffic. In some aspects, SBFD symbols may be configured based on a semi-static cell-specific SBFD time configuration.

For SBFD-aware UEs, collisions between DL reception in one or more DL sub-band(s) and UL transmission in one or more UL sub-band(s) in a SBFD symbol of the component carrier may be addressed or alleviated with proper scheduling. For example, the SBFD-aware UE may experience one or more of the following cases of potential collisions: (1) dynamically scheduled DL reception vs. semi-statically configured UL transmission, (2) semi-statically configured DL reception vs. dynamically scheduled UL transmission, (3) semi-statically configured DL reception vs. semi-statically configured UL transmission, (4) dynamically scheduled DL reception vs. dynamic scheduled UL transmission, (5) SSB vs. dynamically scheduled or configured UL transmission, or (6) dynamic or semi-static DL vs. valid RACH occasion (RO). In addition to collision between any of the above UL transmission and DL reception in the same SBFD symbol(s), the same types of collisions may occur between UL transmission and DL reception in different symbol(s) due to lack of sufficient transition time between transmission and reception at the UE.

In some aspects, the SBFD-aware UE may be configured to operate using carrier aggregation (CA) (or dual connectivity (DC)) where the carriers may be in a same band (e.g., a frequency band) or in different bands, e.g., the CA may be intra-band or inter-band, respectively. The CA (or CA operation), in some aspects, may include one or more component carrier(s) associated with a SBFD mode of operation (e.g., an SBFD CC or SBFD mode CC). The description below provides collision handling rules and/or methods to resolve conflicts across different CCs that may include SBFD CCs. In some aspects, the collision handling rules may build on rules for HD-CA used to resolve collisions of conflicting UL/DL across time division duplexed (TDD) CCs (TDD-CCs).

Various aspects relate generally to how to resolve collisions when a SBFD-aware UE is served by both SBFD cells and non-SBFD cells. Collisions may be resolved in the following two different cases for SBFD-aware operation, a first case in which an HD-CA UE does not support simultaneous transmission (Tx) and reception (Rx) in TDD-TDD inter-band CA/DC. The solutions cover how to determine the reference cell and apply collision handling rules. Some aspects more specifically relate to determining the reference cell and applying collision handling rules. In some examples, a wireless device may be configured to receive, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a SBFD mode of operation and an additional transmission associated with an additional serving cell, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells.

Particular aspects of the subject matter described in this disclosure can be implemented to realize one or more of the following potential advantages. In some examples, by providing rules and/or methods for resolving conflicts and/or collisions involving SBFD CCs, the described techniques can be used to prevent conflicts between transmissions in different directions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

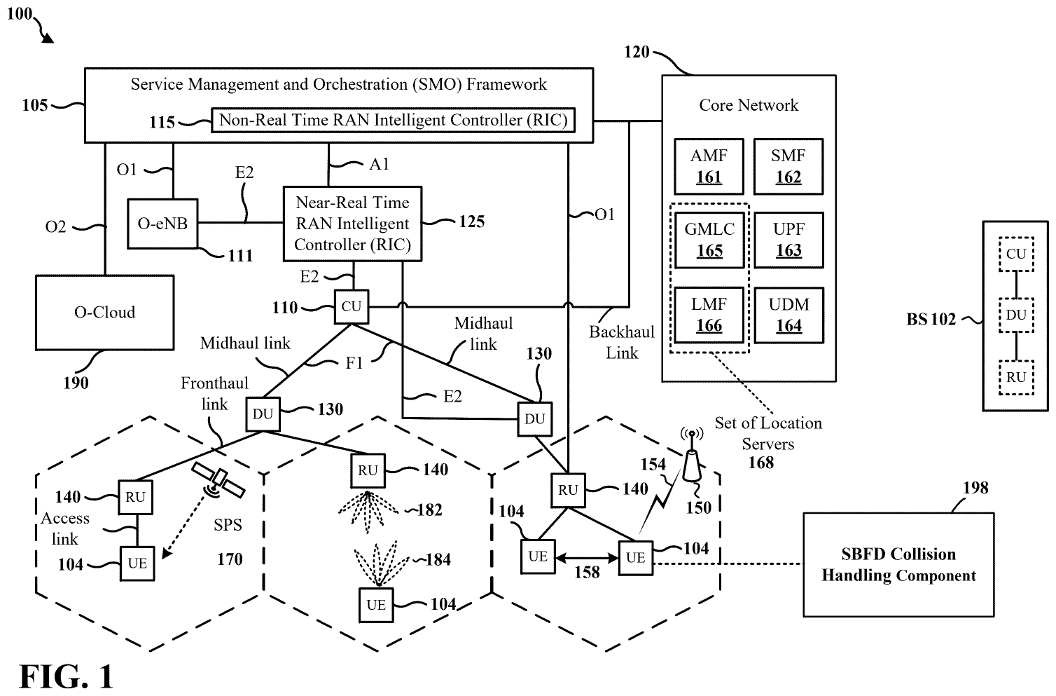

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a SBFD collision handling component 198 that may be configured to receive, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a SBFD mode of operation and an additional transmission associated with an additional serving cell, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells. Although the following description may be focused on 5G NR, the concepts described herein may be applicable to other similar areas, such as LTE, LTE-A, CDMA, GSM, and other wireless technologies.

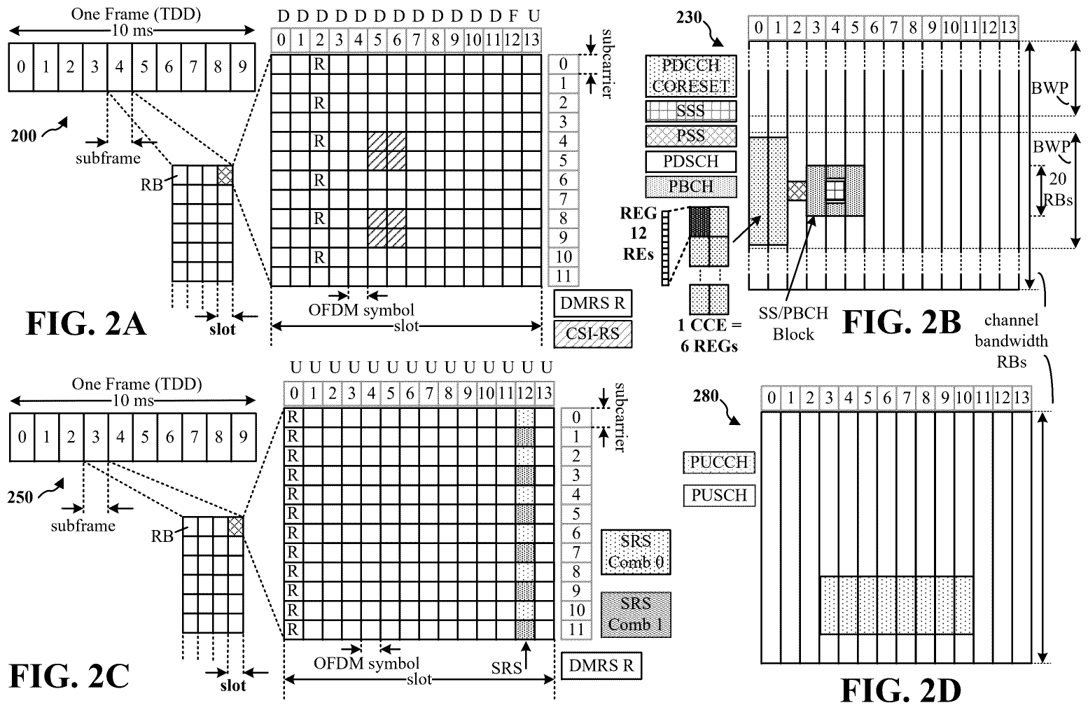

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

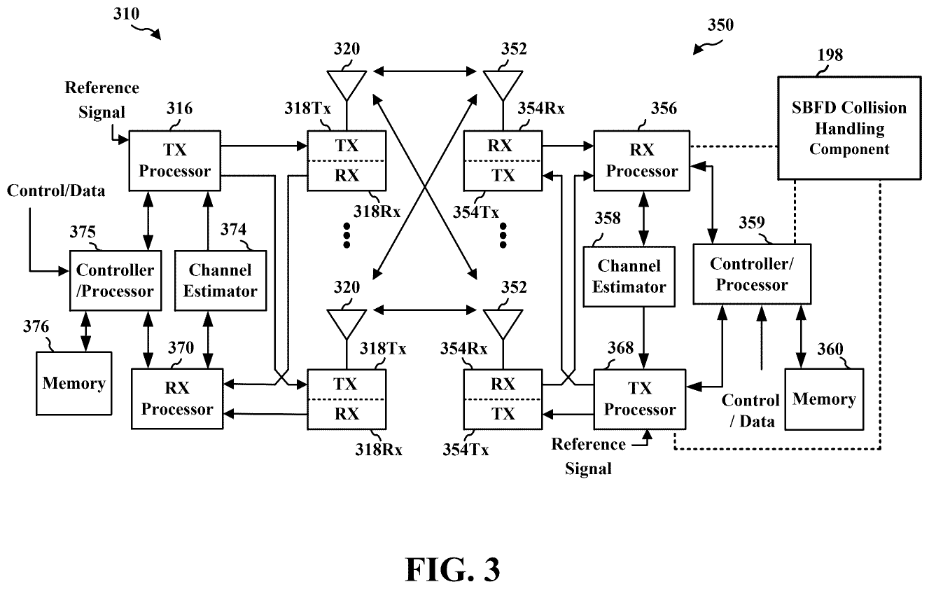

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SBFD collision handling component 198 of FIG. 1.

In some aspects of wireless communication, a plurality of UEs may operate in a HD mode of operation while a base station operates in a SBFD mode of operation. The SBFD mode of operation, in some aspects, may reduce latency by allowing transmission of UL channels and/or signals in an UL sub-band in DL slots and reception of DL channels and/or signals in DL sub-bands in UL slots, may enhance UL coverage, and may allow for flexible and/or dynamic UL/DL resource adaptation based on UL and/or DL traffic. In some aspects, SBFD symbols may be configured based on a semi-static cell-specific SBFD time configuration.

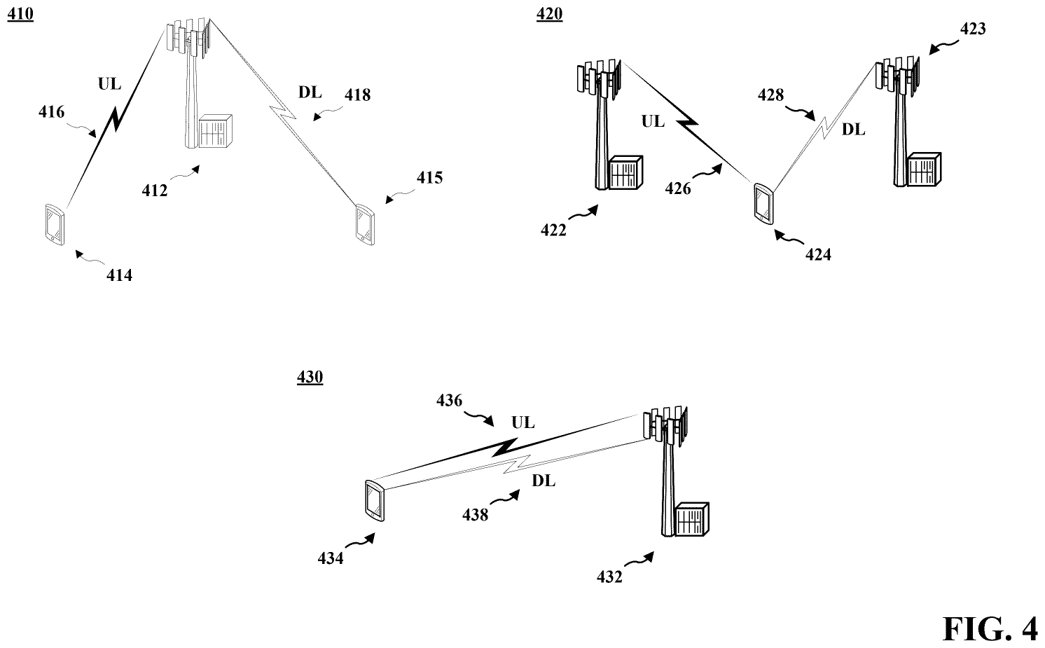

FIG. 4 is a set of diagrams 410, 420, and 430 illustrating a base station 412 engaging in FD communication, a UE 424 engaging in FD communication, and both a base station 432 and a UE 434 engaging in FD communication. Diagram 410 illustrates a base station 412 engaging in FD communication. Specifically, the base station 412 transmits DL data 418 to a first UE 414 and receives UL data 416 from a second UE 415 at a same time. The UL data 416 received by the base station and the DL data 418 transmitted by the base station may result in self-interference at the base station (e.g., interference between the UL data reception and the DL data transmission).

Diagram 420 illustrates a UE 424 engaging in FD communication. Specifically, the UE 424 transmits UL data 426 to a first base station 422 and receives DL data 428 from a second base station 423 at a same time. The UL data 426 transmitted by the UE and the DL data 428 received by the UE may result in self-interference at the UE (e.g., interference between the UL data transmission and the DL data reception). Diagram 430 illustrates a UE 434 and a base station 432 engaging in FD communication with each other. The base station 432 (and the UE 434) may experience self-interference between the UL data reception (transmission) 436 and the DL data transmission (reception) 438.

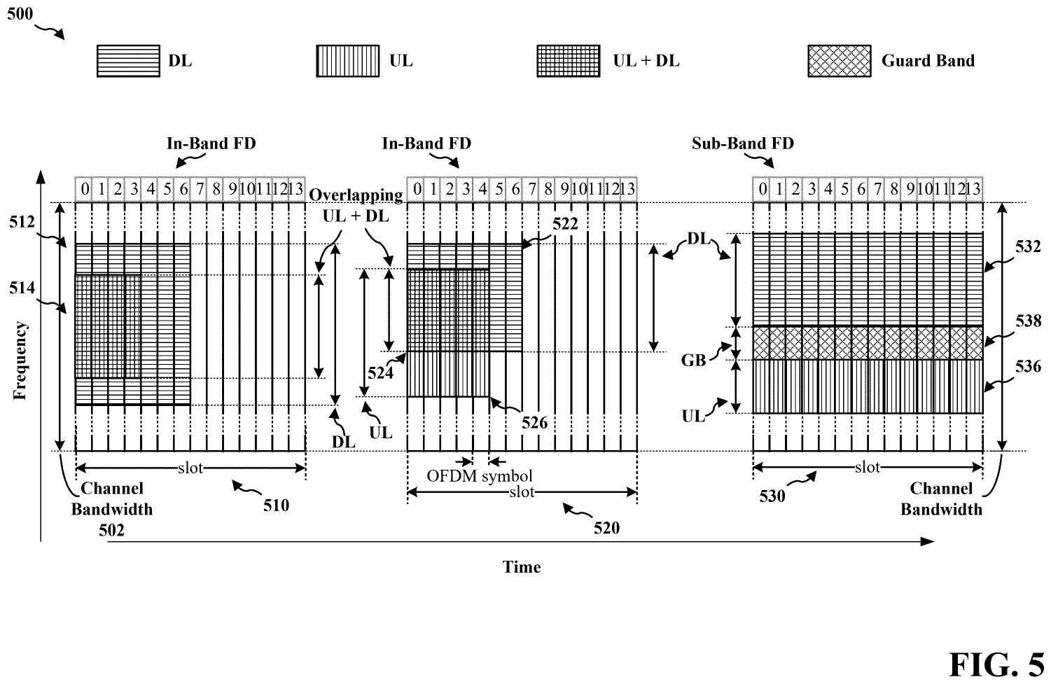

FIG. 5 is a diagram 500 illustrating example resource allocations for IBFD mode communication and SBFD mode communication. Diagram 500 illustrates a set of slots in a particular channel having a particular channel bandwidth 502. A first example slot 510 for IBFD may include a set of DL time-and-frequency resources (e.g., resources) 512 and a set of fully-overlapping UL resources 514. A second example slot 520 for IBFD may include a set of DL resources 522 and a set of partially-overlapping UL resources 526 including a subset of overlapping DL and UL resources 524. The overlapping DL and UL resources 514 and 524 indicate time-and-frequency resources that are used for both UL and DL (e.g., using different beam directionality or other self-interference canceling or mitigating methods). In some aspects, an example slot 530 for SBFD may include non-overlapping sets of UL resources 536, DL resources 532, and guard band resources 538.

In some aspects of wireless communication, e.g., 5G NR, a base station and a UE may communicate via an unlicensed spectrum (e.g., an unlicensed frequency band) as discussed above. In some instances, in an unlicensed spectrum, a base station or UE may perform a LBT procedure to detect if another device (e.g., not the base station or UE) is using (e.g., transmitting over) the unlicensed spectrum. The LBT procedure may measure an energy in a set of RBs (or RB groups) that make up a LBT bandwidth to determine whether an energy in each of the sets of RBs is above (or below) a threshold. Based on the measured (or detected) energy, the base station or UE performing the LBT procedure determines whether (1) the channel is occupied and another LBT procedure is necessary or (2) the channel is unoccupied (available) and a transmission is allowed.

For SBFD-aware UEs, collisions between DL reception in one or more DL sub-band(s) and UL transmission in one or more UL sub-band(s) in a SBFD symbol may be addressed or alleviated with proper scheduling. For example, the SBFD-aware UE may experience one or more of the following cases of potential collisions: (1) dynamically scheduled DL reception vs. semi-statically configured UL transmission, e.g., dynamic PDSCH or CSI-RS collides with configured SRS, PUCCH, or CG PUSCH, (2) semi-statically configured DL reception vs. dynamically scheduled UL transmission, e.g., PDCCH or SPS PDSCH collides with dynamic PUSCH or PUCCH, (3) semi-statically configured DL reception vs. semi-statically configured UL transmission, (4) dynamically scheduled DL reception vs. dynamic scheduled UL transmission, (5) SSB vs. dynamically scheduled or configured UL transmission, e.g., PUSCH, PUCCH, PRACH, SRS, (6) dynamic or semi-static DL vs. valid RO. In addition to collision between any of the above UL transmission and DL reception in the same SBFD symbol(s), the same types of collisions may occur between UL transmission and DL reception in different symbol(s) due to lack of sufficient transition time between transmission and reception at the UE.

In some aspects, the SBFD-aware UE may be configured to operate using CA where the carriers may be in a same band (e.g., a frequency band) or in different bands, e.g., the CA may be intra-band or inter-band, respectively. The CA (or CA operation), in some aspects, may include one or more component carrier(s) associated with a SBFD mode of operation (e.g., an SBFD CC or SBFD mode CC). The description below provides collision handling rules and/or methods to resolve conflicts across different CCs that may include SBFD CCs. In some aspects, the collision handling rules may build on rules for HD-CA used to resolve collisions of conflicting UL/DL across TDD-CCs. The rules, in some aspects, may include rules for conflicts between a reference cell and other cells for half-duplex operation in TDD CA (with different TDD UL/DL configurations across CCs) with a same SCS such as those included in Table 2. In some aspects, the reference cell (for the cases outlined in Table 2) may be an active cell with smallest cell index among the configured multiple serving cells.

TABLE 2
Collision Handling (TDD-CA)

| No | Ref Cell | Other cell | UE behavior | Note |
|---|---|---|---|---|
| 1 | Semi SFI D | Semi SFI U | Allowed to drop U | Dropping U |
| | | | for inter-band | on other cell |
| | | | Error case in | Error case in |
| | | | intra-band | intra band |
| 2 | Semi SFI D | RRC U | Allowed to drop U | Dropping on |
| | | | | other cell |
| 3 | Semi SFI D | Dynamic U | Allowed to drop D | Overriding |
| | | | for inter-band | semi SFI D to |
| | | | Error case in | F on reference |
| | | | intra-band | cell for the |
| | | | | UE |
| 4 | Semi SFI U | Semi SFI D | Allowed to drop D | Dropping D |
| | | | for inter-band | on other cell |
| | | | Error case in | Error case in |
| | | | intra-band | intra band |
| 5 | Semi SFI U | RRC D | Allowed to drop D | Dropping on |
| | | | | other cell |
| 6 | Semi SFI U | Dynamic D | Error | Error |
| 7 | RRC D | RRC U | Allowed to drop U | Dropping on |
| | | | | other cell |
| 8 | RRC U | RRC D | Allowed to drop D | Dropping on |
| | | | | other cell |
| 9 | Dynamic D | Dynamic U | Error | Error |
| 10 | Dynamic U | Dynamic D | Error | Error |
| 11 | RRC U | Semi SFI D | Allowed to drop D | Dropping on |
| | | | | other cell |
| 13 | RRC D | Semi SFI U | Allowed to drop U | Dropping on |
| | | | | other cell |
| 15 | RRC U | Dynamic D | Error | Error |
| 16 | RRC D | Dynamic U | Allowed to drop U | Dropping |
| | | | for inter-band | RRC D on |
| | | | Error case in | reference cell |
| | | | intra-band | |

As can be seen from Table 2, some scenarios may be considered error cases (that may be allowed in the collision handling rules and/or methods to resolve conflicts across different CCs that may include SBFD CCs built on the rules in Table 2) while some scenarios are allowed with rules for dropping either transmission or reception based on the scenario. In some aspects, a “semi slot format indication (SFI) D and/or U” may refer to D and U symbols configured by a particular information element (IE) (e.g., tdd-UL-DL-ConfigurationCommon or tdd-UL-DL-ConfigDedicated), a “semi SFI F” may refer to flexible symbols configured by a particular IE (e.g., tdd-UL-DL-ConfigurationCommon or tdd-UL-DL-ConfigDedicated) when provided to a UE, or when the particular IE (e.g., tdd-UL-DL-ConfigurationCommon and tdd-UL-DL-ConfigDedicated) are not provided to the UE. An “RRC D” may refer to symbols corresponding to a higher-layer configured PDCCH, or a PDSCH, or a CSI-RS on semi SFI F of the same cell and an “RRC U” may refer to symbols corresponding to a higher-layer configured SRS, PUCCH, PUSCH, or PRACH on semi SFI F of the same cell. A “dynamic D and U” may refer to symbols scheduled as D and U by particular DCI formats (e.g., DCI formats other than DCI format 2_0) on a semi SFI F of the same cell.

In some aspects, a UE may be configured with multiple serving cells, may have direction collision handling enabled (e.g., may be provided with an directionCollisionHandling-r16=‘enabled’) for a set of serving cell(s) among multiple configured serving cells, may indicate support of a HD TDD-CA with a same SCS (e.g., a half-DuplexTDD-CA-SameSCS-r16 capability), and may not be configured to monitor PDCCH for detection of a particular DCI format (e.g., a DCI format 2_0) on (any of) the multiple serving cells. Such a UE may determine a reference cell for a symbol as an active cell with the smallest cell index among (1) the configured multiple serving cells if the UE is not capable of simultaneous transmission and reception (e.g., as indicated by simultaneousRxTxInterBandCA) among the multiple serving cells and the multiple serving cells, or (2) the cells of each band respectively if the UE is capable of simultaneous transmission and reception (e.g., as indicated by simultaneousRxTxInterBandCA) for the configured multiple serving cells. A symbol may be configured as downlink or uplink (as indicated by a particular IE (e.g., tdd-UL-DL-ConfigurationCommon or tdd-UL-DL-ConfigDedicated); uplink, if the symbol is flexible and the UE is configured to transmit SRS, PUCCH, PUSCH, or PRACH on the symbol; or downlink, if the symbol is flexible and the UE is configured to receive PDCCH, PDSCH, or CSI-RS on the symbol.

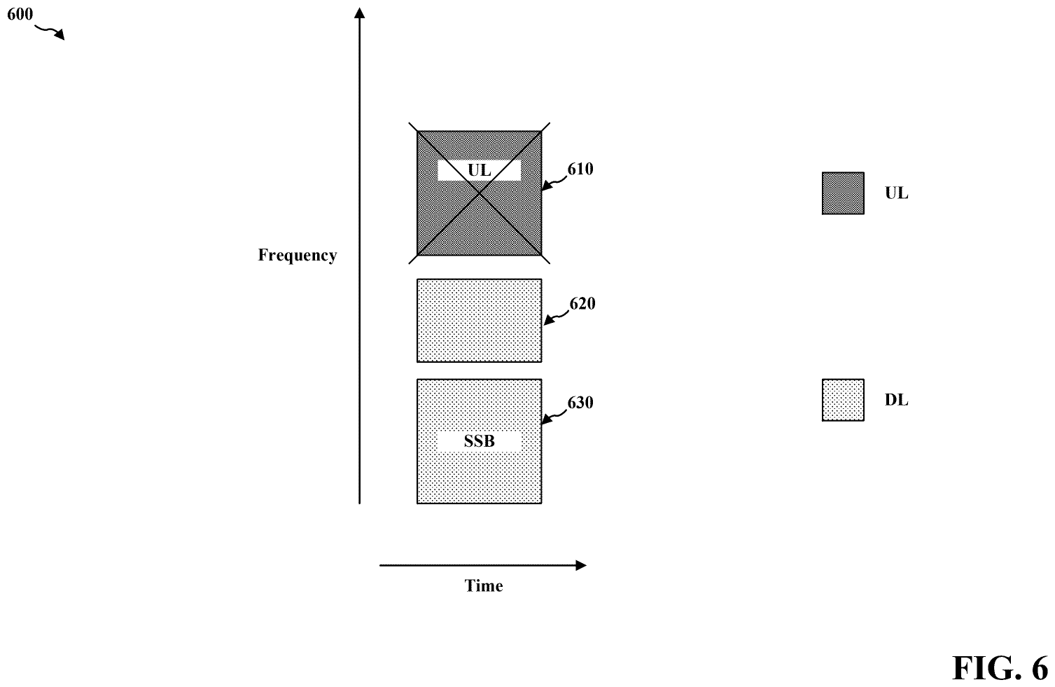

In some aspects, no UL transmission (SRS, PUCCH, PUSCH, and/or PRACH) is expected (or allowed) in a slot if it overlap with SSB of any of the serving cells. FIG. 6 is a diagram 600 illustrating the cancellation of an UL transmission that overlaps with a SSB transmission in accordance with some aspects of the disclosure. The UE, in some aspects, may be scheduled with DL resource 620 and DL resource 630 (including an SSB transmission) and an UL resource 610 including a scheduled UL transmission. Based on the overlap of the UL transmission with the SSB transmission, the UL transmission in the UL resource 610 may be canceled. For example, when a set of symbols of a slot is indicated for SSB reception in a cell, then a UE may not transmit PUCCH, PUSCH, and/or PRACH in the slot if the transmission overlaps with any symbol of the SSB and the UE may not transmit SRS in the set of symbols. For example, for a UE configured with multiple serving cells, having direction collision handling enabled (e.g., is provided with an directionCollisionHandling-r16=‘enabled’) for a set of serving cell(s) among multiple configured serving cells, indicating support of a HD TDD-CA with a same SCS (e.g., a half-DuplexTDD-CA-SameSCS-r16 capability), and not configured to monitor PDCCH for detection of a particular DCI format (e.g., a DCI format 2_0) on (any of) the multiple serving cells, for a set of symbols of a slot that are indicated to the UE for reception of SS/PBCH blocks in a first cell of the multiple serving cells by ssb-PositionsInBurst in SystemInformationBlockType1 or by ssb-PositionsInBurst in ServingCellConfigCommon or, if the UE is not provided dl-OrJoint-TCIStateList, by ssb-PositionsInBurst in SSB-MTCAdditionalPCI associated to physical cell ID with active TCI states for PDCCH or PDSCH, or for a set of symbols of a slot corresponding to SS/PBCH blocks configured for LI beam measurement/reporting, the UE does not transmit PUSCH, PUCCH, or PRACH in the slot if a transmission would overlap with any symbol from the set of symbols, and the UE does not transmit SRS in the set of symbols of the slot in (1) any of the multiple serving cells if the UE is not capable of simultaneous transmission and reception as indicated by simultaneousRxTxInterBandCA among the multiple serving cells, and (2) any one of the cells corresponding to the same band as the first cell, irrespective of any capability indicated by simultaneousRxTxInterBandCA.

In some aspects, if another cell among the cells configured with directionCollisionHandling-r16 operates in the same frequency band as the reference cell, the UE does not expect (1) a symbol to be indicated as downlink, or uplink, on the reference cell and as uplink, or downlink, respectively, on another cell by tdd-UL-DL-ConfigurationCommon or tdd-UL-DL-ConfigDedicated, (2) tdd-UL-DL-ConfigurationCommon or tdd-UL-DL-ConfigDedicated to indicate a symbol as downlink on the reference cell and to detect a DCI format scheduling a transmission on the symbol on another cell, and/or (3) to be configured by higher layers to receive PDCCH, PDSCH, or CSI-RS on a flexible symbol on the reference cell and to detect a DCI format scheduling a transmission on the symbol on another cell.

Whether the reference cell and another cell operate in same or different frequency bands, the UE (1) does not expect tdd-UL-DL-ConfigurationCommon or tdd-UL-DL-ConfigDedicated for the reference cell to indicate a symbol as uplink and to detect a DCI format scheduling a reception on the symbol on another cell, (2) does not expect to be configured by higher layers to transmit SRS, PUCCH, PUSCH, or PRACH on a flexible symbol on the reference cell and to detect a DCI format scheduling a reception on the symbol on another cell, (3) does not transmit a PUCCH, PUSCH, or PRACH that is configured by higher layers on a set of symbols on another cell if at least one symbol from the set of symbols is indicated as downlink by tdd-UL-DL-ConfigurationCommon or tdd-UL-DL-ConfigDedicated or is a symbol corresponding to a PDCCH, PDSCH, or CSI-RS reception that is configured by higher layers on the reference cell, (4) does not transmit a SRS that is configured by higher layers on a set of symbols on another cell if the set of symbols is indicated as downlink by tdd-UL-DL-ConfigurationCommon or tdd-UL-DL-ConfigDedicated or corresponds to a PDCCH, PDSCH, or CSI-RS reception that is configured by higher layers on the reference cell, (5) does not receive a PDCCH, PDSCH, or CSI-RS that is configured by higher layers on a set of symbols on another cell if at least one symbol from the set of symbols is indicated as uplink by tdd-UL-DL-ConfigurationCommon or tdd-UL-DL-ConfigDedicated or is a symbol corresponding to a SRS, PUCCH, PUSCH, or PRACH transmission that is configured by higher layers on the reference cell, (6) assumes a symbol indicated as downlink or uplink by tdd-UL-DL-ConfigurationCommon or tdd-UL-DL-ConfigDedicatedon another cell to be flexible, if the UE is respectively collfigured by higher layers to transmit SRS, PUCCH, PUSCH, or PRACH or to receive PDCCH, PDSCH, or CSI-RS on the reference cell, and (7) does not expect to detect a first DCI format scheduling a transmission or reception on a symbol on a first cell and a second DCI format scheduling a reception or transmission on the symbol on a second cell, respectively.

Various aspects relate generally to how to resolve collisions when a UE is served by both SBFD cells and non-SBFD cells. Collisions may be resolved in the following two different cases for SBFD-aware operation, a first case in which an HD-CA UE does not support simultaneous Tx and Rx in TDD-TDD inter-band CA/DC and a second case in which an HD-CA UE supports simultaneous Tx and Rx in TDD-TDD inter-band CA/DC. The solutions cover how to determine the reference cell and apply collision handling rules. Some aspects more specifically relate to determining the reference cell and apply collision handling rules. In some examples, a wireless device may be configured to receive, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a SBFD mode of operation and an additional transmission associated with an additional serving cell, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells.

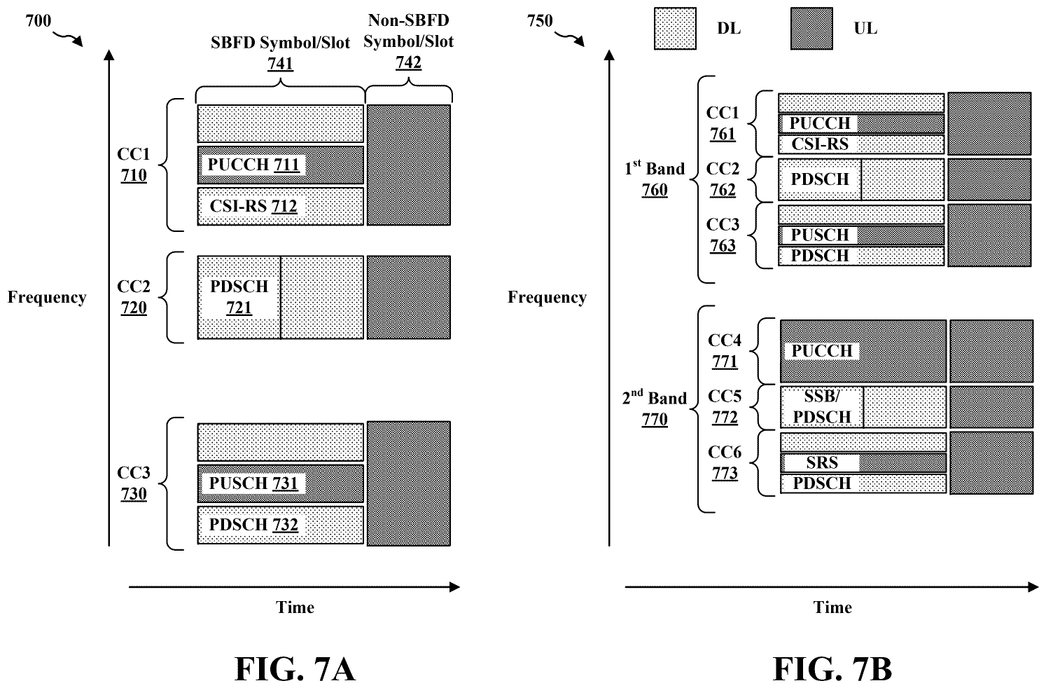

FIG. 7A is a diagram 700 illustrating a first set of component carriers and associated scheduled transmissions in a first frequency band in accordance with some aspects of the disclosure. Diagram 700 illustrates that a first frequency band may include a first SBFD CC (CC1 710), a second TDD CC (CC2 720), and a third SBFD CC (CC3 730). The first and third SBFD CCs, in some aspects, may include two DL sub-bands and an UL sub-band. In the first SBFD CC and during an SBFD symbol and/or slot 741 (e.g., a symbol having both UL and DL resources in a single CC), a PUCCH 711 may be scheduled within the UL sub-band and a CSI-RS 712 may be scheduled within a DL sub-band. Similarly, the second CC may include a single DL resource and, in some aspects, a PDSCH 721 may be scheduled during the DL resource. The third SBFD CC, in some aspects, may include a PUSCH 731 scheduled within an UL sub-band and a PDSCH 732 may be scheduled within a DL sub-band. In some aspects, the SBFD symbol and/or slot 741 may be followed by a non-SBFD symbol and/or slot 742. Conflicts and/or collisions between the UL transmissions and the DL transmissions may be resolved in one of multiple ways as discussed below.

FIG. 7B is a diagram 750 illustrating a first set of component carriers and associated scheduled transmissions in a first frequency band 760 and a second set of component carriers and associated scheduled transmissions in a second frequency band 770 in accordance with some aspects of the disclosure. Diagram 750 illustrates that the first frequency band 760 may include a first SBFD CC (CC1 761), a second CC (CC2 762), and a third SBFD CC (CC3 763). The first and third SBFD CCs, in some aspects, may include two DL sub-bands and an UL sub-band. In the first SBFD CC, a PUCCH may be scheduled within the UL sub-band and a CSI-RS may be scheduled within a DL sub-band. Similarly, the second CC may include a single DL resource and, in some aspects, a PDSCH may be scheduled during the DL resource. The third SBFD CC, in some aspects, may include a PUSCH scheduled within an UL sub-band and a PDSCH may be scheduled within a DL sub-band.

The second frequency band 770 may include a fourth CC (CC4 771), a fifth CC (CC5 772), and a sixth SBFD CC (CC6 773). The fourth CC may include a single UL resource and, in some aspects, a PUCCH may be scheduled during the UL resource. The fifth CC, in some aspects, may include a single DL resource, and an SSB or PDSCH may be scheduled within the DL resource. The sixth SBFD CC, in some aspects, may include two DL sub-bands and an uplink sub-band. In the sixth SBFD CC, a SRS may be scheduled within the UL sub-band and a PDSCH may be scheduled within a DL sub-band. Conflicts and/or collisions between the UL transmissions and the DL transmissions within and/or between frequency bands may be resolved in one of multiple ways as discussed below.

In the examples below, a UE may be configured with one or more prioritization rules. The one or more prioritization rules, in some aspects, may determine a precedence among different scheduled transmissions and/or receptions and may be based on whether the transmission and/or reception is associated with a reference cell or an “other” cell as illustrated in Table 2. The one or more prioritization rules, in some aspects, may include an indication of when to perform per-CC prioritization, cross-CC prioritization (e.g., for intra-band CA and/or for inter-band CA), and/or cross-frequency-band prioritization (e.g., for different frequency bands associated with inter-band CA).

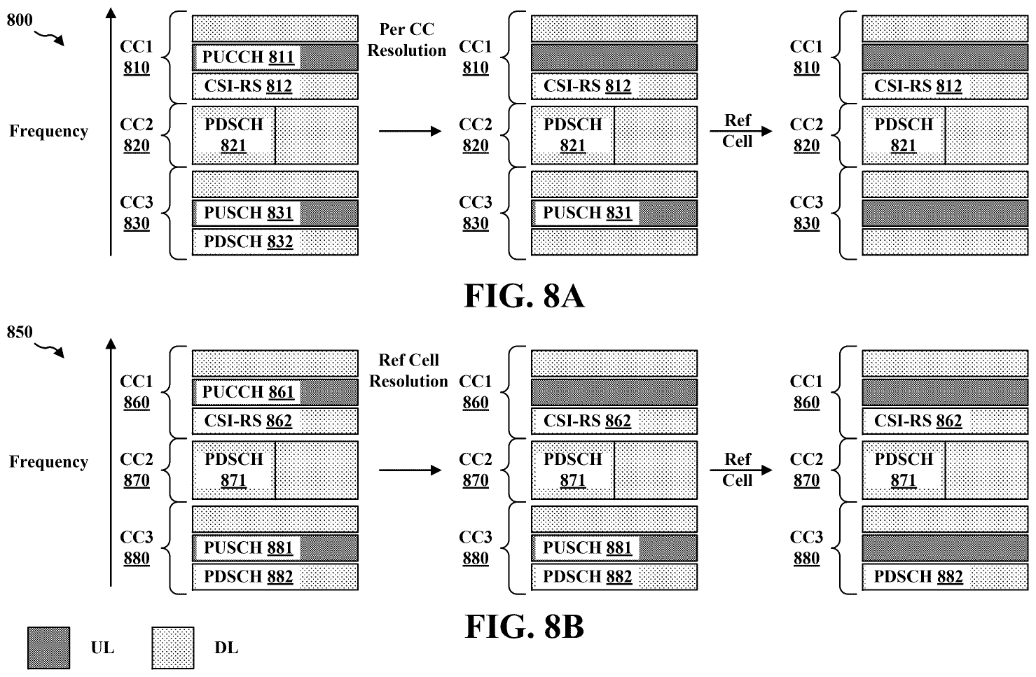

FIG. 8A is a diagram 800 illustrating a first method of resolving conflicts within a single frequency band in accordance with some aspects of the disclosure. Diagram 800 illustrates that a first frequency band may include a first SBFD CC (CC1 810), a second TDD CC (CC2 820), and a third SBFD CC (CC3 830). The first and third SBFD CCs, in some aspects, may include two DL sub-bands and an UL sub-band. In the first SBFD CC, a PUCCH 811 may be scheduled within the UL sub-band and a CSI-RS 812 may be scheduled within a DL sub-band. Similarly, the second CC may include a single DL resource and, in some aspects, a PDSCH 821 may be scheduled during the DL resource. The third SBFD CC, in some aspects, may include a PUSCH 831 scheduled within an UL sub-band and a PDSCH 832 may be scheduled within a DL sub-band. The SBFD-aware UE may first resolve the collision rules within each SBFD CC. For example, in the first SBFD CC, the UE may determine, based on the relative priorities of the PUCCH 811 and the CSI-RS 812, to cancel the PUCCH 811. In some aspects, for the second SBFD CC, the UE may determine, based on the relative priorities of the PUSCH 831 and the PDSCH 832, to cancel the PDSCH 832.

After resolving the conflict within each SBFD CC, the UE may then resolve the conflict(s) across the CCs based on a reference cell (a reference cell selected from among the cells with at least one scheduled transmission and/or reception). The reference cell may be selected and/or identified based on (1) a smallest cell index among the SBFD cells associated with the CA (e.g., to prioritize SBFD cells [associated with SBFD CCs] over TDD cells [associated with TDD CCs]), (2) a smallest cell index among all the cells (e.g., not prioritizing either SBFD cells or TDD cells), or (3) a smallest cell index among the TDD cells (to prioritize TDD cells over SBFD cells). In some aspects, the method of selecting and/or identifying the reference cell may be dependent on the nature of the symbol. For example, for a SBFD symbol (e.g., the SBFD symbol and/or slot 741) the reference cell may be selected and/or identified based on the smallest cell index among the SBFD cells, while for a non-SBFD symbol and/or slot, the may be selected and/or identified based on smallest cell index among the TDD cells. Based on identifying the reference cell (e.g., the SBFD cell associated with the CC1 810), the UE may determine a prioritized transmission direction for the first symbol in accordance with HD-FDD conflict/collision resolution rules in Table 3 below (or the TDD CA rules described in Table 2 or the HD-CA rules described in Table 4 below).

TABLE 3
HD-FDD collision handling rules

| | | | Whether to reuse |
|---|---|---|---|
| Case | DL | UL | R15/16 |
| 1 | Dynamic | UE-dedicated configured | Prioritize dynamic DL |
| | | (CG-PUSCH, or SRS, or | subjected to |
| | | PUCCH by higher layers) | cancellation timeline |
| 2 | Semi-statically configured | Dynamic (PUSCH, | Prioritize dynamic UL |
| | (PDCCH (excluding | PUCCH, SRS or PRACH | |
| | ULCI), SPS PDSCH, CSI- | triggered by PDCCH order) | |
| | RS or PRS) | | |
| 3 | UE-dedicated configured, | UE-dedicated configured | Error case |
| | or Cell-specific configured | | |
| | (PDCCH in Type 0/0A/1/2 | | |
| | CSS set) | | |
| 4 | Dynamic | Dynamic | |
| 5 | SSB | UE-dedicated configured, | SSB is prioritized |
| | | or Dynamic | |
| 8-1 | SSB | Valid RO | Leave for UE |
| 8-2 | Cell-specific configured, or | | implementation |
| | UE-dedicated configured | | |
| | Note: same as semi-static | | |
| | in Case 2 | | |
| 8-3 | Dynamic | | |
| 2-step | SSB, or Semi-statically | MsgA PUSCH | |
| RACH | configured, or Dynamic | | |
| 9-1 | SSB, or cell specific | Valid RO or MsgA PUSCH | up to UE |
| | configured (PDCCH in | | implementation to |
| | Type 0/0A/1/2 CSS set), or | | ensure that the |
| | dedicated configured | | switching time is |
| | (PDCCH in USS/Type 3 | | satisfied |
| | CSS, SPS PDSCH, CSI-RS | | |
| | or DL PRS) | | |
| 9-2 | SSB | dedicated configured (CG | Configured UL |
| | | PUSCH, PUCCH or SRS) | transmission is |
| | | | cancelled |

If the (SBFD-aware) UE supports simultaneous transmission and reception in different frequency bands, in some aspects, the UE may perform the method illustrated in FIG. 8A for each frequency band. For example, referring to FIG. 7B, the procedure above may be performed for the first frequency band 760 as described in relation to FIG. 8A and a similar procedure may be performed for the second frequency band 770 where for the sixth CC (e.g., CC6 773) the PDSCH scheduled in a DL sub-band may be canceled in favor of the SRS scheduled in the UL sub-band (or vice versa) and then a reference cell may be identified and/or selected and the one or more prioritization rules may be used to determine which of the remaining scheduled transmissions and/or receptions will be maintained.

If the (SBFD-aware) UE does not support the simultaneous transmission and reception in different frequency bands, in some aspects, the UE may perform the method illustrated in FIG. 8A across multiple frequency bands (e.g., across the carriers in the multiple frequency bands associated with inter-band CA). For example, referring to FIG. 7B, the procedure above may be performed for the first through sixth carriers (e.g., CC1 761, CC2 762, CC3 763, CC4 771, CC5 772, and CC6 773) as described in relation to FIG. 8A for the first through third carriers (e.g., CC1 761, CC2 762, and CC3 763) such that a conflict and/or collision resolution and/or resolving is performed for the SBFD CC (e.g., CC6 773) as well as the CC1 810 and the CC3 830 (corresponding to CC1 762 and CC3 763 of FIG. 7B) before identifying and/or selecting a reference cell from the full set of CCs associated with the multiple frequency bands (e.g., the first frequency band 760 and the second frequency band 770). After identifying and/or selecting the reference cell, in some aspects, the one or more prioritization rules may be used to determine which of the remaining scheduled transmissions and/or receptions will be maintained. The one or more prioritization rules, in some aspects, may be similar to, or the same as, HD-FDD conflict/collision resolution rules in Table 3 (or the TDD CA rules described in Table 2 or the HD-CA rules described in Table 4). For example, the UE may refrain, based on the determined prioritized transmission direction, from one of transmitting an uplink transmission or receiving a downlink transmission associated with the plurality of serving cells (e.g., the plurality of cells associated with the plurality of CCs).

FIG. 8B is a diagram 850 illustrating a second method of resolving conflicts within a single frequency band in accordance with some aspects of the disclosure. Diagram 850 illustrates that a first frequency band may include a first SBFD CC (CC1 860), a second TDD CC (CC2 870), and a third SBFD CC (CC3 880). The first and third SBFD CCs, in some aspects, may include two DL sub-bands and an UL sub-band. In the first SBFD CC, a PUCCH 861 may be scheduled within the UL sub-band and a CSI-RS 862 may be scheduled within a DL sub-band. Similarly, the second CC may include a single DL resource and, in some aspects, a PDSCH 871 may be scheduled during the DL resource. The third SBFD CC, in some aspects, may include a PUSCH 881 scheduled within an UL sub-band and a PDSCH 882 may be scheduled within a DL sub-band. The SBFD-aware UE may first determine a reference cell (a reference cell selected from among the cells with at least one scheduled transmission and/or reception). The reference cell may be selected and/or identified based on (1) a smallest cell index among the SBFD cells associated with the CA (e.g., to prioritize SBFD cells [associated with SBFD CCs] over TDD-cells [associated with TDD CCs]), (2) a smallest cell index among all the cells (e.g., not prioritizing either SBFD cells or TDD cells), or (3) a smallest cell index among the TDD cells (to prioritize TDD cells over SBFD-cells). In some aspects, the method of selecting and/or identifying the reference cell may be dependent on the nature of the symbol. For example, for a SBFD symbol (e.g., the SBFD symbol and/or slot 741) the reference cell may be selected and/or identified based on the smallest cell index among the SBFD cells, while for a non-SBFD symbol and/or slot, the may be selected and/or identified based on smallest cell index among the TDD cells.

If the reference cell is an SBFD cell, the UE may resolve a conflict within the reference cell to determine a prioritized transmission direction for the SBFD cell. For example, the rules in Table 2 may be used to determine which of an UL transmission or a DL reception to cancel or skip (e.g., not monitor for), respectively, among a plurality of transmissions associated with the SBFD cell. For example, if the first SBFD CC (CC1 860) is identified and/or selected as the reference cell, the UE may determine, based on the relative priorities of the PUCCH 861 and the CSI-RS 862, to cancel the PUCCH 861. Accordingly, the prioritized transmission direction may be a DL transmission direction (e.g., a DL reception). After resolving the conflict within the SBFD CC reference cell and/or identifying a prioritized transmission direction associated with a TDD CC (e.g., a non-SBFD CC) the UE may then resolve the conflict(s) across the CCs based on a reference cell. For example, the UE may use the same identified prioritized direction in the SBFD-CC across the other CCs. This means that UE would apply same ‘direction’ of the reference SBFD-CC across the other TDD and SBFD cells. In another example, based on identifying the reference cell (e.g., the SBFD cell associated with the CC1 860 in the example illustrated in diagram 850), the UE may determine a prioritized transmission direction (e.g., the DL transmission direction or the DL reception) for the first symbol in accordance with HD-FDD conflict/collision resolution rules (or the TDD CA rules described in Table 2 or the HD-CA rules described in Table 4) based on the prioritized transmission direction identified for the reference cell and the remaining scheduled transmission(s) and/or reception(s) after resolving any conflicts in the reference cell. In some aspects, this avoids canceling a transmission and/or reception prematurely in other SBFD cells and/or SBFD CCs, such as PDSCH 882 which is skipped (or canceled) in the first method over PUSCH 881, even though PUSCH 881 is ultimately canceled based on CSI-RS 862 being transmitted by the reference (SBFD) cell.

If the (SBFD-aware) UE supports simultaneous transmission and reception in different frequency bands, in some aspects, the UE may perform the method illustrated in FIG. 8B for each frequency band. For example, referring to FIG. 7B, the procedure above may be performed for the first frequency band 760 as described in relation to FIG. 8B and a similar procedure may be performed for the second frequency band 770 where a reference cell may be determined, identified, and/or selected and then, based on the reference cell, the UE may apply the one or more prioritization rules to determine which scheduled transmission(s) and/or reception(s) should be canceled and/or skipped, respectively. For example, for the sixth CC (e.g., CC6 773) the PDSCH scheduled in a DL sub-band may be canceled in favor of the SRS scheduled in the UL sub-band (or vice versa) if it is selected as the reference cell (or if the reference cell is determined to be the fourth CC (e.g., CC4 771) and the transmission in the fifth CC (e.g., CC5 772) is a PDSCH (and not an SSB). Otherwise the PDSCH may remain uncanceled until at least the application of the one or more prioritization rules across the CCs.

If the (SBFD-aware) UE does not support the simultaneous transmission and reception in different frequency bands, in some aspects, the UE may perform the method illustrated in FIG. 8B across multiple frequency bands (e.g., across the carriers in the multiple frequency bands associated with inter-band CA). For example, referring to FIG. 7B, the procedure above may be performed for the first through sixth carriers (e.g., CC1 761, CC2 762, CC3 763, CC4 771, CC5 772, and CC6 773) as described in relation to FIG. 8B for the first through third carriers (e.g., CC1 761, CC2 762, and CC3 763) such that a conflict and/or collision resolution is performed based on a reference cell selected from the set of cells associated with the first through sixth carriers (e.g., CC1 761, CC2 762, CC3 763, CC4 771, CC5 772, and CC6 773). After identifying and/or selecting the reference cell, in some aspects, the one or more prioritization rules may be used to determine which of the remaining scheduled transmissions and/or receptions will be maintained. For example, the UE may refrain, based on the determined prioritized transmission direction, from one of transmitting an uplink transmission or receiving a downlink transmission associated with the plurality of serving cells (e.g., the plurality of cells associated with the plurality of CCs).

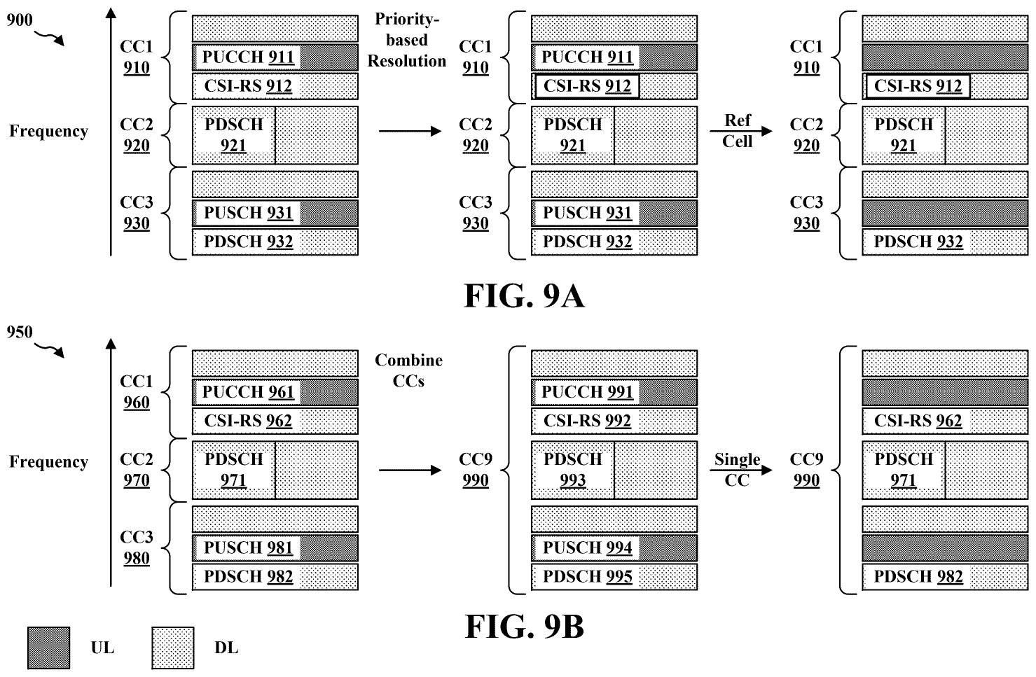

FIG. 9A is a diagram 900 illustrating a third method of resolving conflicts within a single frequency band in accordance with some aspects of the disclosure. Diagram 900 illustrates that a first frequency band may include a first SBFD CC (CC1 910), a second CC (CC2 920), and a third SBFD CC (CC3 930). The first and third SBFD CCs, in some aspects, may include two DL sub-bands and an UL sub-band. In the first SBFD CC, a PUCCH 911 may be scheduled within the UL sub-band and a CSI-RS 912 may be scheduled within a DL sub-band. Similarly, the second CC may include a single DL resource and, in some aspects, a PDSCH 921 may be scheduled during the DL resource. The third SBFD CC, in some aspects, may include a PUSCH 931 scheduled within an UL sub-band and a PDSCH 932 may be scheduled within a DL sub-band. The SBFD-aware UE may apply one or more prioritization rules across the scheduled transmission(s) and/or reception(s) for the CCs of the first frequency band. For example, the UE may apply one or more prioritization rules that prioritize dynamically scheduled DL/UL transmissions/receptions (e.g., scheduled via DCI) over SPS DL/UL transmissions/receptions (e.g., scheduled via a MAC-CE) over RRC scheduled and/or configured DL/UL transmissions/receptions. Based on the highest priority scheduled transmission(s) and/or reception(s), the UE may determine a prioritized transmission direction and determine which scheduled transmission(s) and/or receptions(s) should be canceled and/or skipped. For example, the prioritized transmission direction may be determined to be the same as the direction (either DL or UL) associated with the highest priority scheduled transmission(s) and/or reception(s). The one or more prioritization rules, in some aspects, may be similar to, or the same as, HD-FDD conflict/collision resolution rules (or the TDD CA rules described in Table 2 or the HD-CA rules described in Table 4).

If the (SBFD-aware) UE supports simultaneous transmission and reception in different frequency bands, in some aspects, the UE may perform the method illustrated in FIG. 9A for each frequency band. For example, referring to FIG. 7B, the procedure above may be performed for the first frequency band 760 as described in relation to FIG. 9A and a similar procedure may be performed for the second frequency band 770 across the multiple CCs (e.g., CC4 771, CC5 772, and CC6 773) and based on the one or more prioritization rules may determine which of the remaining scheduled transmissions and/or receptions will be maintained. For example, based on the highest priority scheduled transmission(s) and/or reception(s), the UE may determine a prioritized transmission direction and determine which scheduled transmission(s) and/or receptions(s) should be canceled and/or skipped for the second frequency band independent from the determination made for the first frequency band.

If the (SBFD-aware) UE does not support the simultaneous transmission and reception in different frequency bands, in some aspects, the UE may perform the method illustrated in FIG. 9A across multiple frequency bands (e.g., across the carriers in the multiple frequency bands associated with inter-band CA). For example, referring to FIG. 7B, the procedure above may be performed for the first through sixth carriers (e.g., CC1 761, CC2 762, CC3 763, CC4 771, CC5 772, and CC6 773) as described in relation to FIG. 9A for the first through third carriers (e.g., CC1 761, CC2 762, and CC3 763) such that the SBFD-aware UE may apply one or more prioritization rules across the scheduled transmission(s) and/or reception(s) for the CCs of the first frequency band and the second frequency band and, based on the highest priority scheduled transmission(s) and/or reception(s), the UE may determine a prioritized transmission direction and determine which scheduled transmission(s) and/or receptions(s) should be canceled and/or skipped. For example, the prioritized transmission direction may be determined to be the same as the direction (either DL or UL) associated with the highest priority scheduled transmission(s) and/or reception(s). The one or more prioritization rules, in some aspects, may be similar to, or the same as, HD-FDD conflict/collision resolution rules (or the TDD CA rules described in Table 2 or the HD-CA rules described in Table 4).

FIG. 9B is a diagram 950 illustrating a fourth method of resolving conflicts within a single frequency band in accordance with some aspects of the disclosure. Diagram 950 illustrates that a first frequency band may include a first SBFD CC (CC1 960), a second CC (CC2 970), and a third SBFD CC (CC3 980). The first and third SBFD CCs, in some aspects, may include two DL sub-bands and an UL sub-band. In the first SBFD CC, a PUCCH 961 may be scheduled within the UL sub-band and a CSI-RS 962 may be scheduled within a DL sub-band. Similarly, the second CC may include a single DL resource and, in some aspects, a PDSCH 971 may be scheduled during the DL resource. The third SBFD CC, in some aspects, may include a PUSCH 981 scheduled within an UL sub-band and a PDSCH 982 may be scheduled within a DL sub-band. The SBFD-aware UE may consider the multiple CCs as a single CC (e.g., CC9 990 including PUCCH 991, CSI-RS 992, PDSCH 993, PUSCH 994, and PDSCH 995 corresponding to PUCCH 961, CSI-RS 962, PDSCH 971, PUSCH 981, and PDSCH 982) and apply one or more prioritization rules across the scheduled transmission(s) and/or reception(s) for the single CC (e.g., CC9 including all the CCs of the first frequency band). For example, the UE may apply the one or more prioritization rules that are similar to, or the same as, HD-FDD conflict/collision resolution rules (or the TDD CA rules described in Table 2 or the HD-CA rules described in Table 4) or SBFD-aware conflict resolution rules in an SBFD carrier. For example, the UE may first prioritize one UL transmission among all scheduled/configured UL transmissions and similarly prioritize one DL reception across all configured/schedule DL signals and channels. Based on the one or more prioritization rules, the UE may determine a prioritized transmission direction and determine which scheduled transmission(s) and/or receptions(s) should be canceled and/or skipped. For example, the prioritized transmission direction (either DL or UL) may be determined based on the one or more prioritization rules.

If the (SBFD-aware) UE supports simultaneous transmission and reception in different frequency bands, in some aspects, the UE may perform the method illustrated in FIG. 9B for each frequency band. For example, referring to FIG. 7B, the procedure above may be performed for the first frequency band 760 as described in relation to FIG. 9B and a similar procedure may be performed for the second frequency band 770 across the multiple CCs (e.g., CC4 771, CC5 772, and CC6 773) and based on the one or more prioritization rules may determine which of the remaining scheduled transmissions and/or receptions will be maintained. For example, the UE may apply the one or more prioritization rules that are similar to, or the same as, HD-FDD conflict/collision resolution rules (or the TDD CA rules described in Table 2 or the HD-CA rules described in Table 4). Based on the one or more prioritization rules, the UE may determine a prioritized transmission direction and determine which scheduled transmission(s) and/or receptions(s) should be canceled and/or skipped. For example, the prioritized transmission direction (either DL or UL) may be determined based on the one or more prioritization rules for the second frequency band independent from the determination made for the first frequency band.

If the (SBFD-aware) UE does not support the simultaneous transmission and reception in different frequency bands, in some aspects, the UE may perform the method illustrated in FIG. 9B across multiple frequency bands (e.g., across the carriers in the multiple frequency bands associated with inter-band CA). For example, referring to FIG. 7B, the procedure above may be performed for the first through sixth carriers (e.g., CC1 761, CC2 762, CC3 763, CC4 771, CC5 772, and CC6 773) as if for a single CC as described in relation to FIG. 9B for the first through third carriers (e.g., CC1 761, CC2 762, and CC3 763 aggregated into CC9 990) such that the SBFD-aware UE may apply the one or more prioritization rules that are similar to, or the same as, HD-FDD conflict/collision resolution rules (or the TDD CA rules described in Table 2 or the HD-CA rules described in Table 4). Based on the one or more prioritization rules, the UE may determine a prioritized transmission direction and determine which scheduled transmission(s) and/or receptions(s) should be canceled and/or skipped. For example, the prioritized transmission direction (either DL or UL) may be determined based on the one or more prioritization rules.

In some aspects, if the (SBFD-aware) UE does not support the simultaneous transmission and reception in different frequency bands, the UE may perform, in each band one of the methods described in relation to FIG. 8A, 8B, 9A, or 9B to determine a prioritized transmission direction associated with each band. For example, for methods described above involving and/or including a determination, identification, and/or selection of a reference cell, the UE may determine, identify, and/or select a frequency-band-level reference cell for each frequency band using one of the selection criteria discussed above applied to the cells associated with each frequency band independently. A prioritized transmission direction for each frequency band may then be determined based on the one or more prioritization rules (and the frequency-band-level reference cell). After determining the prioritized transmission direction for each frequency band, the UE may determine a prioritized transmission direction for the combined frequency bands based on identifying a reference cell from the cells associated with the CCs of the combined frequency bands (e.g., the set of all cells associated with the CCs or all cells associated with a transmission and/or reception during a symbol and/or slot via the CCs and/or frequency bands) or based on identifying a reference frequency band from the combined frequency bands (e.g., a frequency band associated with a lowest band index). Accordingly, based on the one or more prioritization rules (including rules for determining one or more reference cells based on which method is used to determine the prioritized transmission direction), the UE may determine a prioritized transmission direction and determine which scheduled transmission(s) and/or receptions(s) should be canceled and/or skipped.

In some aspects, even when the prioritized transmission direction is determined to be a DL direction (a reception direction) based on one of the methods described in relation to FIG. 8A, 8B, 9A, or 9B, the UE may not cancel certain UL transmissions. For example, in some aspects, an UL transmission in a particular CC may not be canceled if a power associated with the UL transmission is below a threshold power. In some aspects, the threshold power may be based on the capabilities of the UE. In some aspects, a new set of prioritization rules may be presented such as in Table 4 below. For example, when a HD-CA (SBFD-aware UE) is configured with multiple serving cells (SBFD and non-SBFD cells) in a same, or a different, band, then to resolve the conflict over multiple overlapping UL/DL within a SBFD cell and/or among multiple cells in one or more non-SBFD symbols, the UE may follow the HD-CA resolution rules presented below in Table 4 (where the prioritization rules better align with SBFD operation) such that a Dynamic D or Dynamic U symbols is prioritized and where, in some aspects, a same behavior is provided for both intra-band and inter-band collisions (when the UE does not support simultaneous transmission and reception on different bands).

TABLE 4
Collision Handling (HD-CA for SBFD-Aware UE)

| | | | | New UE |
|---|---|---|---|---|
| No | Ref cell | Other cell | UE behavior | behavior |
| 1 | Semi SFI D | Semi SFI U | Allowed to drop U | Allowed to |
| | | | for inter-band | drop U |
| | | | Error case in | |
| | | | intra-band | |
| 2 | Semi SFI D | RRC U | Allowed to drop U | Allowed to |
| | | | | drop U |
| 3 | Semi SFI D | Dynamic U | Allowed to drop D | Allowed to |
| | | | for inter-band | drop D |
| | | | Error case in | |
| | | | intra-band | |
| 4 | Semi SFI U | Semi SFI D | Allowed to drop D | Allowed to |
| | | | for inter-band | drop D |
| | | | Error case in | |
| | | | intra-band | |
| 5 | Semi SFI U | RRC D | Allowed to drop D | Allowed to |
| | | | | drop D |
| 6 | Semi SFI U | Dynamic D | Error | Allowed to |
| | | | | drop U |
| 7 | RRC D | RRC U | Allowed to drop U | Allowed to |
| | | | | drop U |
| 8 | RRC U | RRC D | Allowed to drop D | Allowed to |
| | | | | drop D |
| 9 | Dynamic D | Dynamic U | Error | Error |
| 10 | Dynamic U | Dynamic D | Error | Error |
| 11 | RRC U | Semi SFI D | Allowed to drop D | Allowed to |
| | | | | drop D |
| 13 | RRC D | Semi SFI U | Allowed to drop U | Allowed to |
| | | | | drop U |
| 15 | RRC U | Dynamic D | Error | Allowed to |
| | | | | drop U |
| 16 | RRC D | Dynamic U | Allowed to drop D | Allowed to |
| | | | for inter-band | drop D |
| | | | Error case in | |
| | | | intra-band | |

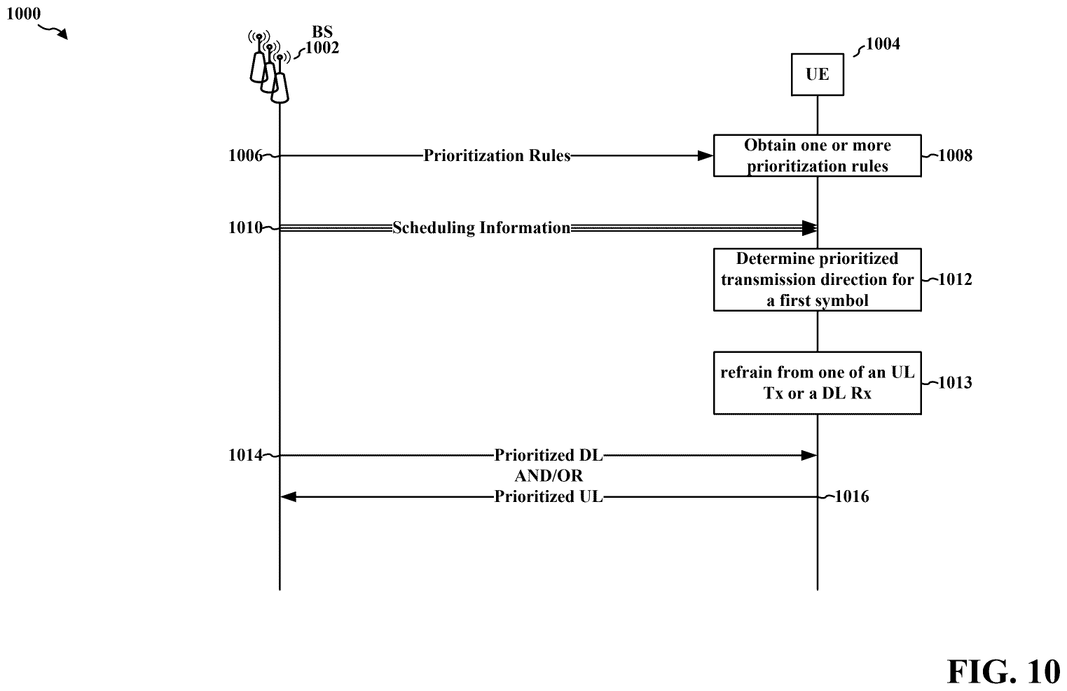

FIG. 10 is a call flow diagram 1000 illustrating a method of wireless communication in accordance with some aspects of the disclosure. The method is illustrated in relation to a base station 1002 (e.g., as an example of a network device or network node that may include one or more components of a disaggregated base station) in communication with a UE 1004 (e.g., as an example of a wireless device). The functions ascribed to the base station 1002, in some aspects, may be performed by one or more components of a network entity, a network node, or a network device (a single network entity/node/device or a disaggregated network entity/node/device as described above in relation to FIG. 1). Similarly, the functions ascribed to the UE 1004, in some aspects, may be performed by one or more components of a wireless device supporting communication with a network entity/node/device. Accordingly, references to “transmitting” in the description below may be understood to refer to a first component of the base station 1002 (or the UE 1004) outputting (or providing) an indication of the content of the transmission to be transmitted by a different component of the base station 1002 (or the UE 1004). Similarly, references to “receiving” in the description below may be understood to refer to a first component of the base station 1002 (or the UE 1004) receiving a transmitted signal and outputting (or providing) the received signal (or information based on the received signal) to a different component of the base station 1002 (or the UE 1004). While discussed in terms of “the base station 1002,” the different communications may be received from one or more base stations, or serving cells, operating in different modes of operation (SBFD, FD, or HD) and in communication with the UE 1004.

The base station 1002 may transmit, and a UE 1004 may receive or otherwise obtain at 1008, a set of one or more prioritization rules 1006. The base station 1002 may also transmit, and the UE 1004 may receive, a set of scheduling transmissions 1010. The set of scheduling transmissions 1010, in some aspects, may include RRC configuration information, MAC-CEs, and or DCI. In some aspects, the RRC configuration may be associated with periodic resources, a MAC-CE may be associated with SPS resources, and DCI may be associated with dynamically scheduled resources. One of the transmissions associated with the set of one or more prioritization rules 1006 or in the set of scheduling transmissions 1010 may include configuration information to configure the UE 1004 with one or more CCs (e.g., associated with carrier aggregation and/or dual connectivity) associated with one or more serving cells and/or with one or more frequency bands.

Based on the scheduling information associated with a first symbol (e.g., scheduling information included in the set of scheduling transmissions 1010), the UE 1004 may, at 1012 determine a prioritized transmission direction for the first symbol as described in one of the FIG. 8A, 8B, 9A, or 9B. Based on the determined prioritized transmission direction, the UE 1004 may at 1013, refrain from transmitting an UL transmission or from receiving a DL transmission and the UE 1004 may receive (or monitor for) a DL transmission 1014 transmitted by the base station 1002 (e.g., at least one serving cell or base station communicating with the UE 1004) and/or may transmit UL transmission 1016 that may be received by the base station 1002 (e.g., at least one serving cell or base station communicating with the UE 1004). In some aspects, both the DL transmission 1014 and the UL transmission 1016 may be received and transmitted, respectively, by the UE 1004. For example, if the UE is capable of simultaneous transmission and reception via different frequency bands (e.g., n1 [from 1920 MHz to 1980 MHz for UL and 2110 MHz to 2170 MHz for DL] and n78 [from 3300 MHz to 3800 MHz for UL/DL]), the DL transmission 1014 may be via a first frequency band, while the UL transmission 1016 may be via a second frequency band. Additionally, if the UE 1004 is not generally capable of simultaneous transmission and reception via different frequency bands, it may be capable of transmitting an UL with a power below a threshold power while receiving a transmission from a base station/serving cell.

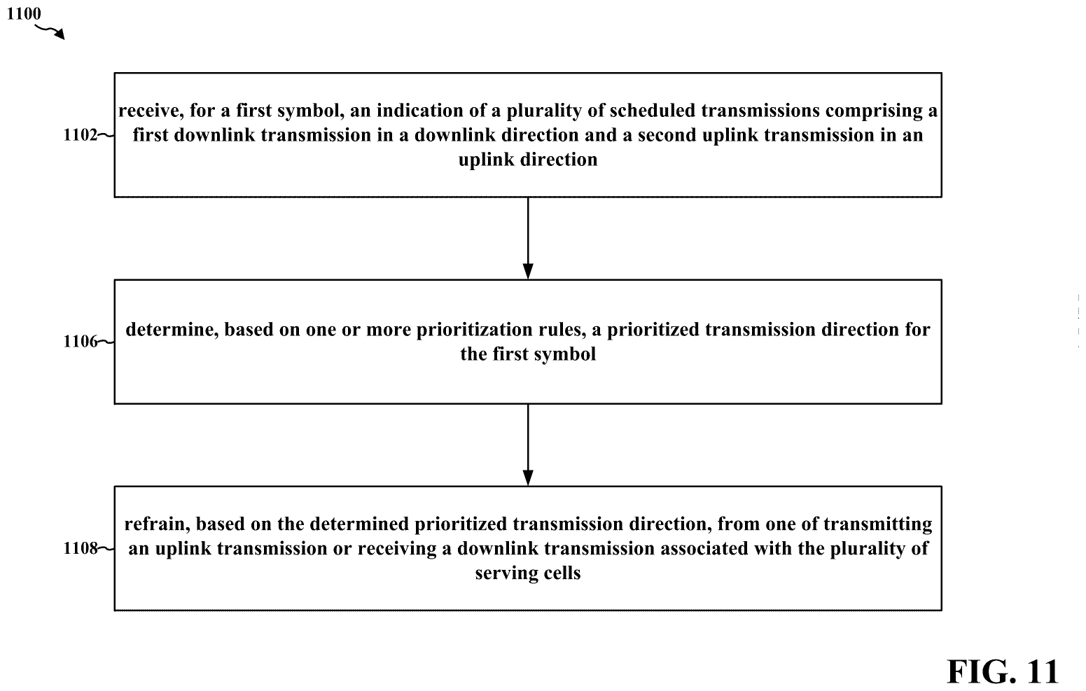

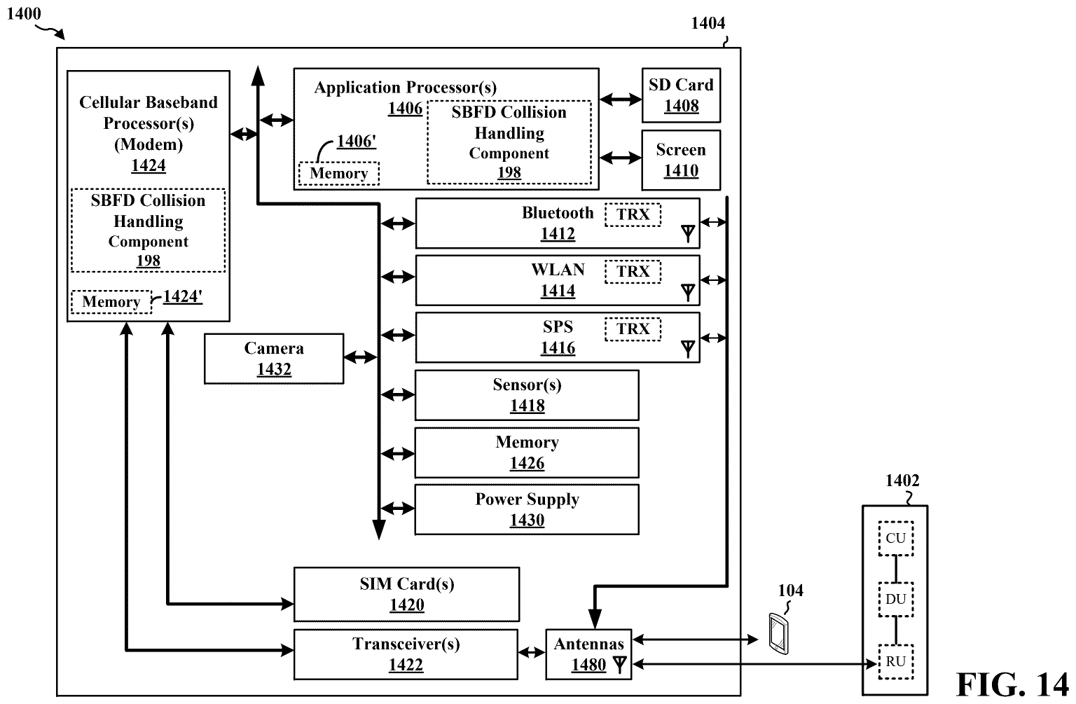

FIG. 11 is a flowchart 1100 of a method of wireless communication. The method may be performed by a UE (e.g., the UE 104, 1004; the apparatus 1404). At 1102, the UE may receive, for a first symbol, an indication of a plurality of scheduled transmissions including a first downlink transmission in a downlink direction and a second uplink transmission in an uplink direction. In some aspects, the plurality of scheduled transmissions may include at least one transmission associated with a first serving cell operating in a SBFD mode of operation and an additional transmission associated with an additional serving cell. For example, 1102 may be performed by application processor(s) 1406, cellular baseband processor(s) 1424, transceiver(s) 1422, antenna(s) 1480, and/or SBFD collision handling component 198 of FIG. 14. In some aspects, the plurality of scheduled transmissions may include transmissions associated with a plurality of component carriers. The one or more prioritization rules, in some aspects, may include a collision handling rule for SBFD operation within a first component carrier. In some aspects, the plurality of scheduled transmissions may include transmissions in a plurality of frequency bands. For example, referring to FIGS. 7B and 10, the UE 1004 may receive, or otherwise obtain at 1008, the set of one or more prioritization rules 1006 and the set of scheduling transmissions 1010 in association with a plurality of frequency bands each including at least one CC associated with a scheduled DL and/or UL transmission.

In some aspects, the UE may determine, for the first symbol, one or more reference serving cells based on a cell index associated with each serving cell in a plurality of serving cells associated with the UE. In some aspects, the plurality of serving cells may include the first serving cell operating in the SBFD mode of operation and the additional serving cell. In some aspects, each serving cell in the plurality of serving cells may be associated with a corresponding cell index, and determining, for a first frequency band associated with at least one serving cell in the plurality of serving cells, a reference serving cell of the one or more reference serving cells may be based on an association of the reference serving cell with one of: a smallest corresponding cell index among a first set of serving cells operating in the SBFD mode of operation in the plurality of serving cells; a (second) smallest corresponding cell index among the plurality of serving cells; or a (third) smallest corresponding cell index among a second set of serving cells not operating in the SBFD mode of operation in the plurality of serving cells. If the first downlink transmission and the second uplink transmission are associated with the SBFD mode of operation, in some aspects, the reference serving cell of the one or more reference serving cells may be associated with the smallest corresponding cell index among the first set of serving cells operating in the SBFD mode of operation in the plurality of serving cells. In some aspects, the first symbol may be a non-SBFD symbol (e.g., a symbol not associated with both a downlink transmission and an uplink transmission) scheduled for the first serving cell, and the reference serving cell of the one or more reference serving cells may be associated with the second smallest corresponding cell index among the second set of serving cells not operating in the SBFD mode of operation in the plurality of serving cells.

Determining, for the first symbol, the one or more reference serving cells, in some aspects, may include determining, for a set of additional frequency bands associated with a corresponding set of serving cells in the plurality of serving cells, a corresponding reference serving cell of the one or more reference serving cells based on an association of the corresponding reference serving cell with one of: a (fourth) smallest corresponding cell index among a first corresponding subset of serving cells operating in the SBFD mode of operation in the corresponding set of serving cells; a (fifth) smallest corresponding cell index among the corresponding set of serving cells; or a (sixth) smallest corresponding cell index among a second corresponding subset of serving cells not operating in the SBFD mode of operation in the corresponding set of serving cells. For example, referring to FIGS. 8A, 8B, 9A, 9B, and 10, the UE 1004 may, at 1012, determine a prioritized transmission direction for the first symbol as described in one of the FIG. 8A, 8B, 9A, or 9B that may include determining one or more reference cells.

At 1106, the UE may determine, based on one or more prioritization rules, a prioritized transmission direction for the first symbol. Determining the prioritized transmission direction for the first symbol, in some aspects, may be based on applying the collision handling rule for SBFD operation across the plurality of component carriers. In some aspects, the determination of the prioritized transmission direction may further be based on the one or more reference serving cells. For example, 1106 may be performed by application processor(s) 1406, cellular baseband processor(s) 1424, transceiver(s) 1422, antenna(s) 1480, and/or SBFD collision handling component 198 of FIG. 14. Determining the prioritized transmission direction, in some aspects, may include determining the prioritized transmission direction based on the one or more prioritization rules applied to a highest priority uplink transmission in the plurality of scheduled transmissions and a highest priority downlink transmission in the plurality of scheduled transmissions. In some aspects, determining the prioritized transmission direction may include determining, based on the one or more prioritization rules, a component-carrier prioritized transmission direction for the first serving cell and determining the prioritized transmission direction for the first symbol based on the one or more prioritization rules, the component-carrier prioritized transmission direction for the first serving cell, and the one or more reference serving cells. The one or more reference serving cells, in some aspects, may include the first serving cell operating in the SBFD mode of operation and determining the prioritized transmission direction may include determining, based on the one or more prioritization rules, a reference-cell prioritized transmission direction for the first serving cell and determining, based on the reference-cell prioritized transmission direction for the first serving cell and the one or more prioritization rules, the prioritized transmission direction. In some aspects, the one or more reference serving cells may include a plurality of reference serving cells in a corresponding plurality of frequency bands and determining the prioritized transmission direction may include, determining, for the corresponding plurality of frequency bands, a plurality of band-specific prioritized transmission directions based on the one or more prioritization rules and the plurality of reference serving cells and determining the prioritized transmission direction for the first symbol based on the plurality of band-specific prioritized transmission directions and one of an index associated with a serving cell or an index associated with a frequency band. The one or more reference serving cells may include a plurality of reference serving cells in a corresponding plurality of frequency bands and determining the prioritized transmission direction may include determining, based on the one or more prioritization rules, a component-carrier prioritized transmission direction for each serving cell operating in the SBFD mode of operation in the plurality of serving cells and determining the prioritized transmission direction for the first symbol based on the one or more prioritization rules and the component-carrier prioritized transmission direction for each serving cell operating in the SBFD mode of operation. In some aspects, the one or more prioritization rules may be a first set of collision handling rules applied to a first set of serving cells in a same band and applied to a second set of serving cells across multiple bands (e.g., a same set of collision handling rules may be applied to serving cells in a same frequency band and to serving cells across multiple frequency bands). For example, referring to FIGS. 8A, 8B, 9A, 9B, and 10, the UE 1004 may, at 1012, determine a prioritized transmission direction for the first symbol as described in one of the FIG. 8A, 8B, 9A, or 9B.

At 1108, the UE may refrain, based on the determined prioritized transmission direction, from one of transmitting an uplink transmission or receiving a downlink transmission associated with the plurality of serving cells. For example, 1108 may be performed by application processor(s) 1406, cellular baseband processor(s) 1424, transceiver(s) 1422, antenna(s) 1480, and/or SBFD collision handling component 198 of FIG. 14. For example, referring to FIGS. 8A, 8B, 9A, 9B, and 10, the UE 1004 may, at 1013, refrain from transmitting an UL transmission (e.g., PUCCH 811, PUSCH 831, PUCCH 861, PUSCH 881) or from receiving a DL transmission (e.g., PDSCH 832) based on the determination at 1012, as described in one of the FIG. 8A, 8B, 9A, or 9B.

In some aspects, the UE may determine that the prioritized transmission direction is a downlink direction (e.g., associated with a first frequency band) and that the second UL transmission (e.g., associated with a second frequency band) is associated with a transmission power below a first threshold. Based on the determination, the UE may transmit the second uplink transmission. For example, referring to FIGS. 8A, 8B, 9A, 9B, and 10, the UE 1004 may, transmit UL transmission 1016 if the UE 1004 is capable of transmitting an UL transmission with a power below a threshold power while receiving a transmission from a base station/serving cell despite the determined prioritized transmission direction being a DL direction as described in one of the FIGS. 8A, 8B, 9A, 9B.

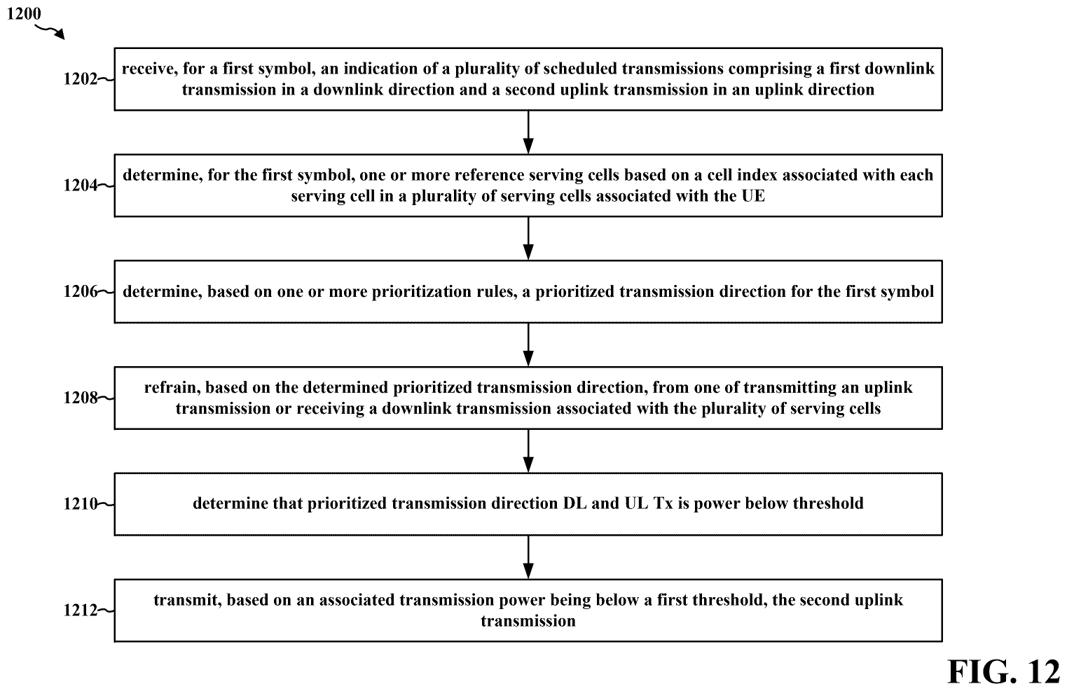

FIG. 12 is a flowchart 1200 of a method of wireless communication. The method may be performed by a UE (e.g., the UE 104, 1004; the apparatus 1404). At 1202, the UE may receive, for a first symbol, an indication of a plurality of scheduled transmissions including a first downlink transmission in a downlink direction and a second uplink transmission in an uplink direction. In some aspects, the plurality of scheduled transmissions may include at least one transmission associated with a first serving cell operating in a SBFD mode of operation and an additional transmission associated with an additional serving cell. For example, 1202 may be performed by application processor(s) 1406, cellular baseband processor(s) 1424, transceiver(s) 1422, antenna(s) 1480, and/or SBFD collision handling component 198 of FIG. 14. In some aspects, the plurality of scheduled transmissions may include transmissions associated with a plurality of component carriers. The one or more prioritization rules, in some aspects, may include a collision handling rule for SBFD operation within a first component carrier. In some aspects, the plurality of scheduled transmissions may include transmissions in a plurality of frequency bands. For example, referring to FIGS. 7B and 10, the UE 1004 may receive, or otherwise obtain at 1008, the set of one or more prioritization rules 1006 and the set of scheduling transmissions 1010 in association with a plurality of frequency bands each including at least one CC associated with a scheduled DL and/or UL transmission.

At 1204, the UE may determine, for the first symbol, one or more reference serving cells based on a cell index associated with each serving cell in a plurality of serving cells associated with the UE. In some aspects, the plurality of serving cells may include the first serving cell operating in the SBFD mode of operation and the additional serving cell. For example, 1204 may be performed by application processor(s) 1406, cellular baseband processor(s) 1424, transceiver(s) 1422, antenna(s) 1480, and/or SBFD collision handling component 198 of FIG. 14. In some aspects, each serving cell in the plurality of serving cells may be associated with a corresponding cell index, and determining, for a first frequency band associated with at least one serving cell in the plurality of serving cells, a reference serving cell of the one or more reference serving cells may be based on an association of the reference serving cell with one of: a smallest corresponding cell index among a first set of serving cells operating in the SBFD mode of operation in the plurality of serving cells; a (second) smallest corresponding cell index among the plurality of serving cells; or a (third) smallest corresponding cell index among a second set of serving cells not operating in the SBFD mode of operation in the plurality of serving cells. If the first downlink transmission and the second uplink transmission are associated with the SBFD mode of operation, in some aspects, the reference serving cell of the one or more reference serving cells may be associated with the smallest corresponding cell index among the first set of serving cells operating in the SBFD mode of operation in the plurality of serving cells. In some aspects, the first symbol may be a non-SBFD symbol (e.g., a symbol not associated with both a downlink transmission and an uplink transmission) scheduled for the first serving cell, and the reference serving cell of the one or more reference serving cells may be associated with the second smallest corresponding cell index among the second set of serving cells not operating in the SBFD mode of operation in the plurality of serving cells.

Determining, for the first symbol, the one or more reference serving cells, in some aspects, may include determining, for a set of additional frequency bands associated with a corresponding set of serving cells in the plurality of serving cells, a corresponding reference serving cell of the one or more reference serving cells based on an association of the corresponding reference serving cell with one of: a (fourth) smallest corresponding cell index among a first corresponding subset of serving cells operating in the SBFD mode of operation in the corresponding set of serving cells; a (fifth) smallest corresponding cell index among the corresponding set of serving cells; or a (sixth) smallest corresponding cell index among a second corresponding subset of serving cells not operating in the SBFD mode of operation in the corresponding set of serving cells. For example, referring to FIGS. 8A, 8B, 9A, 9B, and 10, the UE 1004 may, at 1012, determine a prioritized transmission direction for the first symbol as described in one of the FIG. 8A, 8B, 9A, or 9B that may include determining one or more reference cells.

At 1206, the UE may determine, based on one or more prioritization rules, a prioritized transmission direction for the first symbol. Determining the prioritized transmission direction for the first symbol, in some aspects, may be based on applying the collision handling rule for SBFD operation across the plurality of component carriers. In some aspects, the determination of the prioritized transmission direction may further be based on the one or more reference serving cells. For example, 1206 may be performed by application processor(s) 1406, cellular baseband processor(s) 1424, transceiver(s) 1422, antenna(s) 1480, and/or SBFD collision handling component 198 of FIG. 14. Determining the prioritized transmission direction, in some aspects, may include determining the prioritized transmission direction based on the one or more prioritization rules applied to a highest priority uplink transmission in the plurality of scheduled transmissions and a highest priority downlink transmission in the plurality of scheduled transmissions. In some aspects, determining the prioritized transmission direction may include determining, based on the one or more prioritization rules, a component-carrier prioritized transmission direction for the first serving cell and determining the prioritized transmission direction for the first symbol based on the one or more prioritization rules, the component-carrier prioritized transmission direction for the first serving cell, and the one or more reference serving cells. The one or more reference serving cells, in some aspects, may include the first serving cell operating in the SBFD mode of operation and determining the prioritized transmission direction may include determining, based on the one or more prioritization rules, a reference-cell prioritized transmission direction for the first serving cell and determining, based on the reference-cell prioritized transmission direction for the first serving cell and the one or more prioritization rules, the prioritized transmission direction. In some aspects, the one or more reference serving cells may include a plurality of reference serving cells in a corresponding plurality of frequency bands and determining the prioritized transmission direction may include, determining, for the corresponding plurality of frequency bands, a plurality of band-specific prioritized transmission directions based on the one or more prioritization rules and the plurality of reference serving cells and determining the prioritized transmission direction for the first symbol based on the plurality of band-specific prioritized transmission directions and one of an index associated with a serving cell or an index associated with a frequency band. The one or more reference serving cells may include a plurality of reference serving cells in a corresponding plurality of frequency bands and determining the prioritized transmission direction may include determining, based on the one or more prioritization rules, a component-carrier prioritized transmission direction for each serving cell operating in the SBFD mode of operation in the plurality of serving cells and determining the prioritized transmission direction for the first symbol based on the one or more prioritization rules and the component-carrier prioritized transmission direction for each serving cell operating in the SBFD mode of operation. In some aspects, the one or more prioritization rules may be a first set of collision handling rules applied to a first set of serving cells in a same band and applied to a second set of serving cells across multiple bands (e.g., a same set of collision handling rules may be applied to serving cells in a same frequency band and to serving cells across multiple frequency bands). For example, referring to FIGS. 8A, 8B, 9A, 9B, and 10, the UE 1004 may, at 1012, determine a prioritized transmission direction for the first symbol as described in one of the FIG. 8A, 8B, 9A, or 9B.

At 1208, the UE may refrain, based on the determined prioritized transmission direction, from one of transmitting an uplink transmission or receiving a downlink transmission associated with the plurality of serving cells. For example, 1208 may be performed by application processor(s) 1406, cellular baseband processor(s) 1424, transceiver(s) 1422, antenna(s) 1480, and/or SBFD collision handling component 198 of FIG. 14. For example, referring to FIGS. 8A, 8B, 9A, 9B, and 10, the UE 1004 may, at 1013, refrain from transmitting an UL transmission (e.g., PUCCH 811, PUSCH 831, PUCCH 861, PUSCH 881) or from receiving a DL transmission (e.g., PDSCH 832) based on the determination at 1012, as described in one of the FIG. 8A, 8B, 9A, or 9B.

At 1210, the UE may determine that the prioritized transmission direction is a downlink direction and that the second UL transmission is associated with a transmission power below a first threshold. Based on the determination at 1210, the UE may transmit, at 1212, the second uplink transmission. For example, 1210 and 1212 may be performed by application processor(s) 1406, cellular baseband processor(s) 1424, transceiver(s) 1422, antenna(s) 1480, and/or SBFD collision handling component 198 of FIG. 14. For example, referring to FIGS. 8A, 8B, 9A, 9B, and 10, the UE 1004 may, transmit UL transmission 1016 if the UE 1004 is capable of transmitting an UL transmission with a power below a threshold power while receiving a transmission from a base station/serving cell despite the determined prioritized transmission direction being a DL direction as described in one of the FIGS. 8A, 8B, 9A, 9B.

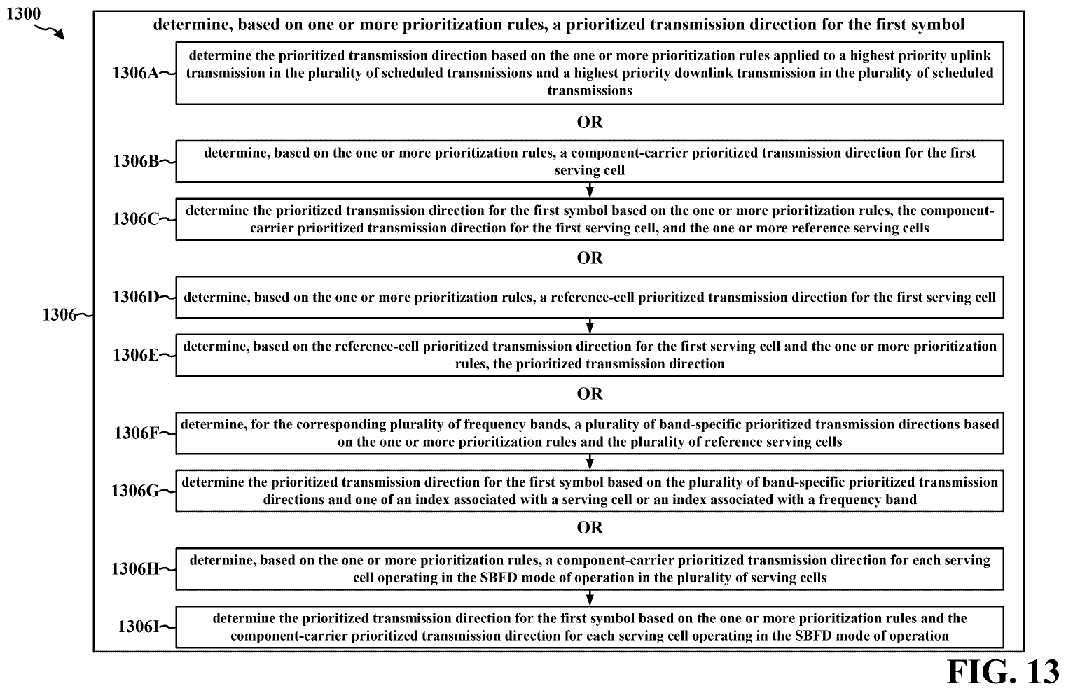

FIG. 13 is a flowchart 1300 of a method of wireless communication. The method may be performed by a UE (e.g., the UE 104, 1004; the apparatus 1404). At 1306, the UE may determine, based on one or more prioritization rules, a prioritized transmission direction for the first symbol. Determining the prioritized transmission direction for the first symbol, in some aspects, may be based on applying the collision handling rule for SBFD operation across the plurality of component carriers. In some aspects, the determination of the prioritized transmission direction may further be based on the one or more reference serving cells. To determine the prioritized transmission direction, in some aspects, the UE may determine, at 1306A, the prioritized transmission direction based on the one or more prioritization rules applied to a highest priority uplink transmission in the plurality of scheduled transmissions and a highest priority downlink transmission in the plurality of scheduled transmissions. In some aspects, to determine the prioritized transmission direction, the UE may, at 1306B, determine, based on the one or more prioritization rules, a component-carrier prioritized transmission direction for the first serving cell and, at 1306C, determine the prioritized transmission direction for the first symbol based on the one or more prioritization rules, the component-carrier prioritized transmission direction for the first serving cell, and the one or more reference serving cells. The one or more reference serving cells, in some aspects, may include the first serving cell operating in the SBFD mode of operation and to determine the prioritized transmission direction, the UE may, at 1306D determine, based on the one or more prioritization rules, a reference-cell prioritized transmission direction for the first serving cell and, at 1306E, determine, based on the reference-cell prioritized transmission direction for the first serving cell and the one or more prioritization rules, the prioritized transmission direction. In some aspects, the one or more reference serving cells may include a plurality of reference serving cells in a corresponding plurality of frequency bands and to determine the prioritized transmission direction, the UE may, at 1306F, determine, for the corresponding plurality of frequency bands, a plurality of band-specific prioritized transmission directions based on the one or more prioritization rules and the plurality of reference serving cells and, at 1306G, determine the prioritized transmission direction for the first symbol based on the plurality of band-specific prioritized transmission directions and one of an index associated with a serving cell or an index associated with a frequency band. The one or more reference serving cells may include a plurality of reference serving cells in a corresponding plurality of frequency bands and to determine the prioritized transmission direction, the UE may, at 1306H, determine, based on the one or more prioritization rules, a component-carrier prioritized transmission direction for each serving cell operating in the SBFD mode of operation in the plurality of serving cells and, at 1306I, determine the prioritized transmission direction for the first symbol based on the one or more prioritization rules and the component-carrier prioritized transmission direction for each serving cell operating in the SBFD mode of operation. For example, 1306 and 1306A-1306I may be performed by application processor(s) 1406, cellular baseband processor(s) 1424, transceiver(s) 1422, antenna(s) 1480, and/or SBFD collision handling component 198 of FIG. 14. Referring to FIGS. 8A, 8B, 9A, 9B, and 10, for example, the UE 1004 may, at 1012, determine a prioritized transmission direction for the first symbol as described in one of the FIG. 8A, 8B, 9A, or 9B.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize one or more antennas 1480 for communication. The cellular baseband processor(s) 1424 communicates through the transceiver(s) 1422 via the one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the SBFD collision handling component 198 may be configured to receive, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a SBFD mode of operation and an additional transmission associated with an additional serving cell, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells. The SBFD collision handling component 198 may be within the cellular baseband processor(s) 1424, the application processor(s) 1406, or both the cellular baseband processor(s) 1424 and the application processor(s) 1406. The SBFD collision handling component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a sub-band full duplex (SBFD) mode of operation and an additional transmission associated with an additional serving cell. The apparatus 1404, and in particular the cellular baseband processor(s) 1424 and/or the application processor(s) 1406, may include means for determining, based on one or more prioritization rules, a prioritized transmission direction for the first symbol. The apparatus 1404, and in particular the cellular baseband processor(s) 1424 and/or the application processor(s) 1406, may include means for refraining, based on the determined prioritized transmission direction, from one of transmitting an uplink transmission or receiving a downlink transmission associated with the plurality of serving cells. The apparatus 1404, and in particular the cellular baseband processor(s) 1424 and/or the application processor(s) 1406, may include means for determining the prioritized transmission direction based on the one or more prioritization rules applied to a highest priority uplink transmission in the plurality of scheduled transmissions and a highest priority downlink transmission in the plurality of scheduled transmissions. The apparatus 1404, and in particular the cellular baseband processor(s) 1424 and/or the application processor(s) 1406, may include means for determining, for the first symbol, one or more reference serving cells based on a cell index associated with each serving cell in a plurality of serving cells associated with the UE, where the plurality of serving cells comprises the first serving cell operating in the SBFD mode of operation and the additional serving cell, where the determination of the prioritized transmission direction is further based on the one or more reference serving cells. The apparatus 1404, and in particular the cellular baseband processor(s) 1424 and/or the application processor(s) 1406, may include means for determining, based on the one or more prioritization rules, a component-carrier prioritized transmission direction for the first serving cell. The apparatus 1404, and in particular the cellular baseband processor(s) 1424 and/or the application processor(s) 1406, may include means for determining the prioritized transmission direction for the first symbol based on the one or more prioritization rules, the component-carrier prioritized transmission direction for the first serving cell, and the one or more reference serving cells. The apparatus 1404, and in particular the cellular baseband processor(s) 1424 and/or the application processor(s) 1406, may include means for determining, based on the one or more prioritization rules, a reference-cell prioritized transmission direction for the first serving cell. The apparatus 1404, and in particular the cellular baseband processor(s) 1424 and/or the application processor(s) 1406, may include means for determining, based on the reference-cell prioritized transmission direction for the first serving cell and the one or more prioritization rules, the prioritized transmission direction. The apparatus 1404, and in particular the cellular baseband processor(s) 1424 and/or the application processor(s) 1406, may include means for determining, for the corresponding plurality of frequency bands, a plurality of band-specific prioritized transmission directions based on the one or more prioritization rules and the plurality of reference serving cells. The apparatus 1404, and in particular the cellular baseband processor(s) 1424 and/or the application processor(s) 1406, may include means for determining the prioritized transmission direction for the first symbol based on the plurality of band-specific prioritized transmission directions and one of an index associated with a serving cell or an index associated with a frequency band. The apparatus 1404, and in particular the cellular baseband processor(s) 1424 and/or the application processor(s) 1406, may include means for determining, based on the one or more prioritization rules, a component-carrier prioritized transmission direction for each serving cell operating in the SBFD mode of operation in the plurality of serving cells. The apparatus 1404, and in particular the cellular baseband processor(s) 1424 and/or the application processor(s) 1406, may include means for determining the prioritized transmission direction for the first symbol based on the one or more prioritization rules and the component-carrier prioritized transmission direction for each serving cell operating in the SBFD mode of operation. The apparatus 1404, and in particular the cellular baseband processor(s) 1424 and/or the application processor(s) 1406, may include means for transmitting, based on an associated transmission power being below a first threshold, the second uplink transmission. The apparatus 1404 may further include means for performing any of the aspects described in connection with the flowcharts in FIGS. 11-13, and/or performed by the UE in the communication flow of FIG. 10. The means may be the SBFD collision handling component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

Various aspects relate generally to how to resolve collisions when a UE is served by both SBFD cells and non-SBFD cells. Collisions may be resolved in the following two different cases for SBFD-aware operation, a first case in which an HD-CA UE does not support simultaneous Tx and Rx in TDD-TDD inter-band CA/DC and a second case in which an HD-CA UE supports simultaneous transmission (Tx) and reception (Rx) in TDD-TDD inter-band CA/DC. The solutions cover how to determine the reference cell and apply collision handling rules. Some aspects more specifically relate to determining the reference cell and apply collision handling rules. In some examples, a wireless device may be configured to receive, for a first symbol, an indication of a plurality of scheduled transmissions comprising a first downlink transmission in a downlink direction and a second uplink transmission in an uplink direction, where the plurality of scheduled transmissions comprises at least one transmission associated with a first serving cell operating in a sub-band full duplex (SBFD) mode of operation and an additional transmission associated with an additional serving cell, determine, based on one or more prioritization rules, a prioritized transmission direction for the first symbol, and refrain, based on the determined prioritized transmission direction, from one of transmitting an uplink transmission or receiving a downlink transmission associated with the plurality of serving cells.

Particular aspects of the subject matter described in this disclosure can be implemented to realize one or more of the following potential advantages. In some examples, by providing rules and/or methods for resolving conflicts and/or collisions involving SBFD CCs, the described techniques can be used to prevent conflicts between transmissions in different directions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a user equipment (UE), comprising: receiving, for a first symbol, an indication of a plurality of scheduled transmissions comprising a first downlink transmission in a downlink direction and a second uplink transmission in an uplink direction, wherein the plurality of scheduled transmissions comprises at least one transmission associated with a first serving cell operating in a sub-band full duplex (SBFD) mode of operation and an additional transmission associated with an additional serving cell; determining, based on one or more prioritization rules, a prioritized transmission direction for the first symbol; and refraining, based on the determined prioritized transmission direction, from one of transmitting an uplink transmission or receiving a downlink transmission associated with the plurality of serving cells.

Aspect 2 is the method of aspect 1, wherein determining the prioritized transmission direction comprises: determining the prioritized transmission direction based on the one or more prioritization rules applied to a highest priority uplink transmission in the plurality of scheduled transmissions and a highest priority downlink transmission in the plurality of scheduled transmissions.

Aspect 3 is the method of aspect 1, further comprising: determining, for the first symbol, one or more reference serving cells based on a cell index associated with each serving cell in a plurality of serving cells associated with the UE, wherein the plurality of serving cells comprises the first serving cell operating in the SBFD mode of operation and the additional serving cell, wherein the determination of the prioritized transmission direction is further based on the one or more reference serving cells.

Aspect 4 is the method of aspect 3, wherein determining the prioritized transmission direction comprises: determining, based on the one or more prioritization rules, a component-carrier prioritized transmission direction for the first serving cell; and determining, after determination of the component-carrier prioritized transmission direction for the first serving cell, the prioritized transmission direction for the first symbol based on the one or more prioritization rules, the component-carrier prioritized transmission direction for the first serving cell, and the one or more reference serving cells.

Aspect 5 is the method of aspect 3, wherein the one or more reference serving cells comprises the first serving cell operating in the SBFD mode of operation and wherein determining the prioritized transmission direction comprises: determining, based on the one or more prioritization rules, a reference-cell prioritized transmission direction for the first serving cell; and determining, based on the reference-cell prioritized transmission direction for the first serving cell and the one or more prioritization rules, the prioritized transmission direction.

Aspect 6 is the method of aspect 3, wherein each serving cell in the plurality of serving cells is associated with a corresponding cell index, and wherein determining, for a first frequency band associated with at least one serving cell in the plurality of serving cells, a reference serving cell of the one or more reference serving cells is based on an association of the reference serving cell with one of: a smallest corresponding cell index among a first set of serving cells operating in the SBFD mode of operation in the plurality of serving cells; a second, smallest, corresponding cell index among the plurality of serving cells; or a third, smallest, corresponding cell index among a second set of serving cells not operating in the SBFD mode of operation in the plurality of serving cells.

Aspect 7 is the method of aspect 6, wherein the first downlink transmission and the second uplink transmission are associated with the SBFD mode of operation and the reference serving cell of the one or more reference serving cells is associated with the smallest corresponding cell index among the first set of serving cells operating in the SBFD mode of operation in the plurality of serving cells.

Aspect 8 is the method of aspect 6, wherein the first symbol is a non-SBFD symbol scheduled for the first serving cell, and wherein the reference serving cell of the one or more reference serving cells is associated with the second smallest corresponding cell index among the second set of serving cells not operating in the SBFD mode of operation in the plurality of serving cells.

Aspect 9 is the method of any of aspects 6 to 8, wherein determining, for a set of additional frequency bands associated with a corresponding set of serving cells in the plurality of serving cells, a corresponding reference serving cell of the one or more reference serving cells in each frequency band of the set of additional frequency bands is based on an association of the corresponding reference serving cell with one of: a fourth, smallest, corresponding cell index among a first corresponding subset of serving cells operating in the SBFD mode of operation in the corresponding set of serving cells; a fifth, smallest, corresponding cell index among the corresponding set of serving cells; or a sixth, smallest, corresponding cell index among a second corresponding subset of serving cells not operating in the SBFD mode of operation in the corresponding set of serving cells.

Aspect 10 is the method of aspect 1, wherein the plurality of scheduled transmissions comprises transmissions associated with a plurality of component carriers, and wherein the one or more prioritization rules comprise a collision handling rule for SBFD operation within a first component carrier and determining the prioritized transmission direction for the first symbol is based on applying the collision handling rule for SBFD operation across the plurality of component carriers.

Aspect 11 is the method of any of aspects 1 to 10, wherein the plurality of scheduled transmissions comprises transmissions in a plurality of frequency bands.

Aspect 12 is the method of aspect 3, wherein the one or more reference serving cells comprise a plurality of reference serving cells in a corresponding plurality of frequency bands, and wherein determining the prioritized transmission direction for the first symbol comprises: determining, for the corresponding plurality of frequency bands, a plurality of band-specific prioritized transmission directions based on the one or more prioritization rules and the plurality of reference serving cells; and determining the prioritized transmission direction for the first symbol based on the plurality of band-specific prioritized transmission directions and one of a first index associated with a serving cell or a second index associated with a frequency band.

Aspect 13 is the method of aspect 3, wherein the one or more reference serving cells comprise a plurality of reference serving cells in a corresponding plurality of frequency bands, and wherein determining the prioritized transmission direction for the first symbol comprises: determining, based on the one or more prioritization rules, a component-carrier prioritized transmission direction for each serving cell operating in the SBFD mode of operation in the plurality of serving cells; and determining the prioritized transmission direction for the first symbol based on the one or more prioritization rules and the component-carrier prioritized transmission direction for each serving cell operating in the SBFD mode of operation.

Aspect 14 is the method of any of aspects 1 to 13, wherein the prioritized transmission direction is a downlink direction associated with a first frequency band, the method further comprising: transmitting, based on an associated transmission power being below a first threshold, the second uplink transmission, wherein the second uplink transmission is associated with a second frequency band.

Aspect 15 is the method of aspect 14, wherein the threshold is based on a capability of the UE.

Aspect 16 is the method of aspect 1, wherein the one or more prioritization rules is a first set of collision handling rules applied to a first set of serving cells in a same band and applied to a second set of serving cells across multiple bands.

Aspect 17 is an apparatus for wireless communication at a device including a memory and at least one processor coupled to the memory and, based at least in part on information stored in the memory, the at least one processor is configured to implement any of aspects 1 to 16.

Aspect 18 is the apparatus of aspect 17, further including a transceiver or an antenna coupled to the at least one processor.

Aspect 19 is an apparatus for wireless communication at a device including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
receive, for a first symbol, an indication of a plurality of scheduled transmissions comprising a first downlink transmission in a downlink direction and a second uplink transmission in an uplink direction, wherein the plurality of scheduled transmissions comprises at least one transmission associated with a first serving cell operating in a sub-band full duplex (SBFD) mode of operation and an additional transmission associated with an additional serving cell in a plurality of serving cells;
determine, based on one or more prioritization rules, a prioritized transmission direction for the first symbol; and
refrain, based on the determined prioritized transmission direction, from one of transmitting an uplink transmission or receiving a downlink transmission associated with the plurality of serving cells.

2. The apparatus of claim 1, wherein to determine the prioritized transmission direction, the at least one processor, individually or in any combination, is configured to:
determine the prioritized transmission direction based on the one or more prioritization rules applied to a highest priority uplink transmission in the plurality of scheduled transmissions and a highest priority downlink transmission in the plurality of scheduled transmissions.

3. The apparatus of claim 1, the at least one processor, individually or in any combination, is further configured to:
determine, for the first symbol, one or more reference serving cells based on a cell index associated with each serving cell in a plurality of serving cells associated with the UE, wherein the plurality of serving cells comprises the first serving cell operating in the SBFD mode of operation and the additional serving cell, wherein the determination of the prioritized transmission direction is further based on the one or more reference serving cells.

4. The apparatus of claim 3, wherein to determine the prioritized transmission direction, the at least one processor, individually or in any combination, is configured to:
determine, based on the one or more prioritization rules, a component-carrier prioritized transmission direction for the first serving cell; and
determine, after determination of the component-carrier prioritized transmission direction for the first serving cell, the prioritized transmission direction for the first symbol based on the one or more prioritization rules, the component-carrier prioritized transmission direction for the first serving cell, and the one or more reference serving cells.

5. The apparatus of claim 3, wherein the one or more reference serving cells comprises the first serving cell operating in the SBFD mode of operation and wherein to determine the prioritized transmission direction, the at least one processor, individually or in any combination, is configured to:
determine, based on the one or more prioritization rules, a reference-cell prioritized transmission direction for the first serving cell; and
determine, based on the reference-cell prioritized transmission direction for the first serving cell and the one or more prioritization rules, the prioritized transmission direction.

6. The apparatus of claim 3, wherein each serving cell in the plurality of serving cells is associated with a corresponding cell index, and wherein the at least one processor, individually or in any combination, is configured to determine, for a first frequency band associated with at least one serving cell in the plurality of serving cells, a reference serving cell of the one or more reference serving cells based on an association of the reference serving cell with one of:
a smallest corresponding cell index among a first set of serving cells operating in the SBFD mode of operation in the plurality of serving cells;
a second, smallest, corresponding cell index among the plurality of serving cells; or
a third, smallest, corresponding cell index among a second set of serving cells not operating in the SBFD mode of operation in the plurality of serving cells.

7. The apparatus of claim 6, wherein the first downlink transmission and the second uplink transmission are associated with the SBFD mode of operation and the reference serving cell of the one or more reference serving cells is associated with the smallest corresponding cell index among the first set of serving cells operating in the SBFD mode of operation in the plurality of serving cells.

8. The apparatus of claim 6, wherein the first symbol is a non-SBFD symbol scheduled for the first serving cell, and wherein the reference serving cell of the one or more reference serving cells is associated with the second, smallest, corresponding cell index among the second set of serving cells not operating in the SBFD mode of operation in the plurality of serving cells.

9. The apparatus of claim 6, wherein the at least one processor, individually or in any combination, is configured to determine, for a set of additional frequency bands associated with a corresponding set of serving cells in the plurality of serving cells, a corresponding reference serving cell of the one or more reference serving cells in each frequency band of the set of additional frequency bands based on an association of the corresponding reference serving cell with one of:
a fourth, smallest, corresponding cell index among a first corresponding subset of serving cells operating in the SBFD mode of operation in the corresponding set of serving cells;
a fifth, smallest, corresponding cell index among the corresponding set of serving cells; or
a sixth, smallest, corresponding cell index among a second corresponding subset of serving cells not operating in the SBFD mode of operation in the corresponding set of serving cells.

10. The apparatus of claim 1, wherein the plurality of scheduled transmissions comprises transmissions associated with a plurality of component carriers, and wherein the one or more prioritization rules comprise a collision handling rule for SBFD operation within a first component carrier and the at least one processor, individually or in any combination, is configured to determine the prioritized transmission direction for the first symbol based on applying the collision handling rule for SBFD operation across the plurality of component carriers.

11. The apparatus of claim 1, wherein the plurality of scheduled transmissions comprises transmissions in a plurality of frequency bands.

12. The apparatus of claim 3, wherein the one or more reference serving cells comprise a plurality of reference serving cells in a corresponding plurality of frequency bands, and wherein to determine the prioritized transmission direction, the at least one processor, individually or in any combination, is configured to:
determine, for the corresponding plurality of frequency bands, a plurality of band-specific prioritized transmission directions based on the one or more prioritization rules and the plurality of reference serving cells; and
determine the prioritized transmission direction for the first symbol based on the plurality of band-specific prioritized transmission directions and one of a first index associated with a serving cell or a second index associated with a frequency band.

13. The apparatus of claim 3, wherein the one or more reference serving cells comprise a plurality of reference serving cells in a corresponding plurality of frequency bands, and wherein to determine the prioritized transmission direction, the at least one processor, individually or in any combination, is configured to:
determine, based on the one or more prioritization rules, a component-carrier prioritized transmission direction for each serving cell operating in the SBFD mode of operation in the plurality of serving cells; and
determine the prioritized transmission direction for the first symbol based on the one or more prioritization rules and the component-carrier prioritized transmission direction for each serving cell operating in the SBFD mode of operation.

14. The apparatus of claim 1, wherein the prioritized transmission direction is the downlink direction associated with a first frequency band, the at least one processor, individually or in any combination, is further configured to:
transmit, based on an associated transmission power being below a first threshold, the second uplink transmission, wherein the second uplink transmission is associated with a second frequency band.

15. The apparatus of claim 14, wherein the threshold is based on a capability of the UE.

16. The apparatus of claim 1, wherein the one or more prioritization rules is a first set of collision handling rules applied to a first set of serving cells in a same band and applied to a second set of serving cells across multiple bands.

17. A method for wireless communication at a user equipment (UE), comprising:
receiving, for a first symbol, an indication of a plurality of scheduled transmissions comprising a first downlink transmission in a downlink direction and a second uplink transmission in an uplink direction, wherein the plurality of scheduled transmissions comprises at least one transmission associated with a first serving cell operating in a sub-band full duplex (SBFD) mode of operation and an additional transmission associated with an additional serving cell;
determining, based on one or more prioritization rules, a prioritized transmission direction for the first symbol; and
refraining, based on the determined prioritized transmission direction, from one of transmitting an uplink transmission or receiving a downlink transmission associated with the plurality of serving cells.

18. The method of claim 17, further comprising:
determining, for the first symbol, one or more reference serving cells based on a cell index associated with each serving cell in a plurality of serving cells associated with the UE, wherein the plurality of serving cells comprises the first serving cell operating in the SBFD mode of operation and the additional serving cell, wherein the determination of the prioritized transmission direction is further based on the one or more reference serving cells.

19. The method of claim 18, wherein the one or more reference serving cells comprises the first serving cell operating in the SBFD mode of operation and wherein determining the prioritized transmission direction comprises:
determining, based on the one or more prioritization rules, a reference-cell prioritized transmission direction for the first serving cell; and
determining, based on the reference-cell prioritized transmission direction for the first serving cell and the one or more prioritization rules, the prioritized transmission direction.

20. A computer-readable medium storing computer executable code at a user equipment (UE), the code when executed by a processor causes the processor to:
receive, for a first symbol, an indication of a plurality of scheduled transmissions comprising a first downlink transmission in a downlink direction and a second uplink transmission in an uplink direction, wherein the plurality of scheduled transmissions comprises at least one transmission associated with a first serving cell operating in a sub-band full duplex (SBFD) mode of operation and an additional transmission associated with an additional serving cell;
determine, based on one or more prioritization rules, a prioritized transmission direction for the first symbol; and
refrain, based on the determined prioritized transmission direction, from one of transmitting an uplink transmission or receiving a downlink transmission associated with the plurality of serving cells.
